(19) United States
(12) Patent Application Publication
(10) Pub. No.: US 2008/0289538 A1
(43) Pub. Date: Nov. 27, 2008

(54) Pigment preparations of pasty or gellike consistency

(76) Inventors: Holger Friedrich, Krefeld (DE); Jurgen Kischkewitz, Ratingen (DE)

Correspondence Address: LANXESS CORPORATION, 111 RIDC PARK WEST DRIVE, PITTSBURGH, PA, 15275-1112, US

(21) Appl. No.: 12/151,634

(22) Filed: May 8, 2008

(30) Foreign Application Priority Data
May 23, 2007 (DE) 10 2007 023 912.4

(51) Int. Cl. C04B 24/36; C09B 67/20; C04B 16/00; C08K 5/3415; D21H 21/28

(52) U.S. Cl. 106/284.02; 106/410; 106/413; 106/712; 524/88; 106/429; 106/436; 106/453; 106/456; 162/162

(57) ABSTRACT

The present invention relates to pasty or gellike pigment preparations for colouring lime-bound and/or cement-bound building materials, asphalt, paints, varnishes, paper or plastics and also to a method of preparing them.

The present invention relates to pasty or gellike pigment preparations for colouring lime-bound and/or cement-bound building materials, asphalt, paints, varnishes, paper or plastics and also to a method of preparing them.

### BACKGROUND OF THE INVENTION

The increase in coloured design in our surroundings over recent decades has produced a sharp rise in the use of pigments. Since many coloured materials include at least a proportion of inorganic pigments, the demand for these, too, has steadily risen. Inorganic pigments are nowadays encountered in numerous areas of everyday life. They are used, for example, for colouring building materials such as concrete and asphalt, emulsion paints, varnishes, paper and plastics. Iron oxide pigments, nowadays in volume terms the largest group among the inorganic chromatic pigments, have been used since prehistoric times. The cave paintings at Altamira (Spain) and Lascaux (France), which are around 15 000 years old, provide evidence of the use of naturally occurring iron oxide as a pigment. The ancient Egyptians, Greeks and Romans too used naturally occurring iron oxide pigments as colorants. For a long time now the natural occurrence has no longer been able to cover this demand, particularly in view of the continual and ongoing increase in the qualitative requirements in terms of the performance properties. The synthetically produced pigments have enhanced opacity, brilliance of colour and consistency of quality when compared to their naturally occurring counterparts.

In the processing of pigments, achieving the ideal colour requires that the pigments be ground down into primary particles. Accordingly the modern production processes for pigments usually include such a grinding operation. On account of their finely divided nature, however, the resultant pigments are very dusty and tend to adhere to packaging and machine components and also when stored in silos. In the case of toxicologically hazardous substances, therefore, measures must be taken during processing to avoid risks to humans and the environment through dusts that are formed. Even in the case of unobjectionable inert substances, however, such as iron oxide pigments, for example, the avoidance of dust nuisance is an increasing market requirement.

### Supply Forms for Colouring Building Materials:

For the colouring of building materials, such as concrete products, for example, the pigments are used primarily in powder form. In their ground form they have the advantage of ready dispersibility. The complete and homogeneous distribution of such pigment powders takes place in the concrete mixer in a short time—generally within a few minutes. The disadvantage of these fine powders is that they do not have good flow characteristics and frequently clump together and form lumps in the course of storage. This hinders precise metering when processing. A further disadvantage of the powders is that they tend to form dust.

Avoiding dust and improving metering in the application of pigments for colouring building materials is a prime objective. Since the end of the 1980s this objective has been achieved more or less by application of granulation methods to pigments. Examples of such granulation methods include agglomerative granulation and spray drying granulation.

Spray drying granulation starts from pigment suspensions to which granule binders are added. Granulation by the spray drying method takes place in co-current or counter-current flow via single-fluid or dual-fluid nozzles or via atomizing driers, producing granules having an average particle size of 50 to 500 μm. The corresponding methods are described in numerous patents and are known to the skilled person. These methods use predominantly water-soluble binders. Thus DE 3 619 363 A1, EP 0 268 645 A1 and EP 0 365 046 A1 start from organic substances such as ligninsulphonates, formaldehyde condensates, gluconic acids and sulphonated polyglycol ethers, for example, whereas DE 3 918 694 A1 and U.S. Pat. No. 5,215,583 A1 teach the possibility of using inorganic salts as well, such as silicate and phosphate, for example. More recently, granulates with water-insoluble binders as well have been proposed. For instance, U.S. Pat. No. 6,596,072 B1 and U.S. Pat. No. 6,695,990 B1 add hydrophilic clay binders, such as aluminosilicates or puzzolanes. DE 103 19 483 A1 discloses a dispersible pigment concentrate, used among other things for colouring building materials such as concrete, that comprises at least one pigment and also, if desired, binder, dispersant and wetting agent, and containing a disintegration assistant which on contact with water (in sufficient amount) brings about, within one minute, the substantially complete disintegration of the primary structure of the concentrate without mechanical exposure, releasing the pigment. Disintegration assistants used include cellulose fibres with a particle size between 10 and 2000 μm. DE 197 31 698 A1 has already disclosed the use of disintegrants in the production of granules said to be suitable for colouring building materials or asphalt. A disintegrant usually comprises highly hydrophilic polymers having an appropriately great absorption capacity for water. DE 100 02 559 B4 and DE 100 66 190 B4 as well have already disclosed the use of disintegrants in granule production.

Owing to the drop formation stage, spray granulation requires the use of highly fluid, in other words highly mobile, suspensions. Since the drying operation involves evaporation of a relatively large quantity of water, the method is very energy-intensive and therefore unfavourable on grounds of the environment and climate protection. In the case of pigments which have been produced by a dry production process, such as a calcining process, for example, spray granulation implies an additional step with high energy costs, since the pigment already obtained in the dry state must be suspended in water again and dried. Moreover, in the case of spray granulation, there is a more or less substantial fraction of fine material obtained in the dust filter, which must be recycled to the production operation.

Agglomerative granulation can be carried out—starting from pigment powder—in mixers with high turbulence, in a fluidized bed method or else in rotary plates (pelletizing plates) or rotary drums (pelletizing drums). A feature common to all of these methods is the high level of binder required, usually water, with the consequence of drying as a necessary additional step. Here again, granules of different sizes are obtained, particularly if there is insufficient binder for the amount of powder, or the actual distribution is less than optimum. In that case a certain fraction of the granule particles may become too large, while on the other hand there are also excessively small fractions present which as a result still form dust. It is therefore necessary to classify the granules formed, and to return oversize and undersize. Granulation in a rotary plate (pelletizing plate) leads to a broad particle size spectrum. Where this is unwanted, owing to the poor dispersibility of oversized particles, intensive use of operatives is necessary to monitor the granulating operation, and manual control of the amount of seed must be practised in order to optimize granule production. Here as well, typically, the product is classified with recycling of the oversize and undersize.

As well as agglomerative granulation and spray drying granulation the prior art has also described other granulation methods. Thus, for example, EP 0 507 046 A1 discloses a combination of spray granulation and agglomerative granulation. DE 3 619 363 A1 and EP 0 268 645 A1 except the application of a compacting method.

In recent years it has also been possible, increasingly, for granules produced by briquetting and compression to establish themselves within the market for the purpose of colouring building materials. DE 196 38 042 A1 and DE 196 49 756 A1 describe inorganic pigment granules comprising dry pigments, ready-produced product for example, by blending with one or more auxiliaries, compacting and further steps such as comminuting, screening and recycling of oversize and/or fines. The granules obtained can be enveloped with an additional coat that serves to increase the stability and as an aid in processing. These granules have since acquired large-scale commercial success in the colouring of building materials. A disadvantage of this method is that it starts from dry pigment powders which may have been ground. In other words, once again, an energy-intensive production step is required which is unfavourable on grounds of environmental and climate protection.

DE 4 336 613 A1 describes inorganic pigment granules comprising dry pigments, ready-produced product for example, by blending with binders, compacting and further steps such as treading in a screening granulator, with subsequent agglomerative granulation on a rotary plate or in a rotary drum. The pigment granules produced in this way are suitable for colouring building materials such as concrete or asphalt. The disadvantage already mentioned above in the context of the compression and bricketting granules applies in this case as well.

The skilled person is aware of further methods of preparing inorganic pigment granules suitable for applications including the colouring of building materials. DE 28 44 710 A1 describes the granulation of pigments in a fluid bed with granulating assistants, where dry pigment powder is sprayed with water. U.S. Pat. No. 6,758,893 B2 discloses an extrusion method in which the pigments are mixed with 1% to 25% by weight of water in order to give a moist powder. The moist powder is extruded through a die having at least one opening. The granules obtained are dried to a residual moisture content of less than 1% by weight, comminuted and screened. The extrusion granules prepared by this extrusion method are suitable for colouring concrete. U.S. Pat. No. 6,562,120 B1 describes a very similar method. It involves a combination of an extrusion method and compacting method. A moist mixture of pigment and water is extruded through at least one die, the mixture being compacted at the same time. Subsequently the granules are dried to a residual moisture content of less than 5% by weight. The three last-mentioned methods are very unfavourable in terms of cost and environmental protection, since dry pigments are mixed with large quantities of water which must be expelled again at a later point in the production process, meaning that, once again, an energy-intensive and high-cost drying step is required.

Another dust-free and automatically meterable supply form for pigments for colouring building materials, developed at the beginning of the 1980s, is the liquid colour, also called a slurry. The pigment is dispersed in water with the aid of a number of adjuvants. These adjuvants are essentially wetting and dispersing additives which allow the production of liquid colours having a high pigment content coupled to a relatively low viscosity. The reason for the relatively low viscosity is to allow the liquid colour to be metered effectively. The solids content of the commercially available liquid colours generally is not more than 55%. At the same time the wetting and dispersing additives are also intended largely to reduce the sedimentation propensity, so that sufficient stability—even in the case of a prolonged storage period—is achieved. The attendant improvements in comparison to the powder pigment are, essentially, absence of dust and greater ease of metering. A further advantage of the liquid colour is that, through the dispersing operation involved in producing the liquid colour, the pigments are at least partly comminuted into their primary particles. As a result there is a very quick development of the full colour strength when the liquid colour is incorporated into the building material mix. The liquid colour, however, also has a number of disadvantages. In contrast to solid pigment forms such as powder or granules, liquid colour can be stored only for a limited time. Over time it tends to separate—that is, the pigment settles at the bottom of the containers. This sedimentation produces unwanted inhomogeneities in the liquid colour, since there is a higher pigment content at the bottom of the container than at the top. For this reason the manufacturers advise homogenizing the liquid colours in the event of prolonged storage—and in any case before use. For this purpose either the liquid colours can be stirred, or else compressed air is blown into the containers, where it swirls and so rehomogenizes the pigment suspension. The high water content of the liquid colours represents a problem particularly in winter at frost temperatures. This makes scheduling and warehousing difficult. Another disadvantage of the liquid colour occurs if its containers become damaged. The liquid colour leaks out, causing contamination to the environment and to employees.

An alternative form of the liquid colour is a liquid colour which is prepared by the user itself, by mixing the pigment with water immediately before use, known as an on-site slurry. The user obtains pigment powders or granules from the manufacturer, stirs them into water on site, and then meters the suspension into its building material mix. Since such suspensions generally do not contain further adjuvants they are not stable to sedimentation and hence also exhibit constantly non-homogeneous characteristics during stirring. This form of liquid colour has receded into the background over recent years.

DE 299 10 022 U1 describes thermal carbon black for the black colouring of cement-bound building materials. According to the teaching of DE 299 10 022 U1 it is advantageous to use an aqueous liquid suspension (slurry) rather than a powder or granule. WO 01/55050 discloses a high-viscosity pasty aqueous slurry based on thermal carbon black for the black colouring of cementitious articles. The high-viscosity pasty aqueous slurries have very high solids contents of more than 50%. In spite of this they are to be conveyable using pumps and also to be readily and reliably meterable. Such high solids contents, however, have to be stabilized by addition of wetting agents and dispersants.

DE 29 08 202 A1 describes a method of producing hydrous, non-dusting, readily dispersible carbon black preparations having a powder like, bead like or liquid character, the water content being adjusted so that the preparations contain between 30% and 80% water. In the production of the carbon black preparations it is also possible to use wetting agents and/or dispersants. The carbon black preparations can be used as colorants in the paper, cardboard and cement industries. The production method disclosed, however, is not applicable to other pigments.

The commercially available aqueous pigment preparations comprise wetting agents and dispersants in order to give suspensions having very high solids contents while retaining acceptable viscosities that allow processing. The addition of dispersants acts as a plasticizer in the concrete mixes. They retard the solidification of the concrete, and also influence the water-cement ratio and have an effect on the concrete's consistency.

### Supply Forms for Colouring Asphalt:

As well as the abovementioned DE 4 336 613 A1, whose description includes that of a method of colouring asphalt with inorganic pigment granules, and the aforementioned DE 100 03 248 A1, which discloses pigment granules for colouring asphalt, bitumen, bituminous substances and tar, DE 42 14 195 A1 as well discloses a method of colouring asphalt with inorganic pigment granules, using oils as binders for the pigment granules. This is a simple granulation method. These cases are also subject to the abovementioned disadvantages of the granulation methods.

The abovementioned DE 197 31 698 A1 discloses the use of disintegrant in the production of granules which are said to be suitable, among other things, for the colouring of asphalt. A disintegrant usually comprises highly hydrophilic polymers having a correspondingly great absorption capacity for water. Granules of this kind would not disperse quickly enough or well enough in an asphalt mix, since in the processing of asphalt there is no water present at all.

Despite the description in the prior art of numerous pigment granules for colouring asphalt, and of a multiplicity of production methods, the asphalt industry still almost exclusively uses the pigments in a powder form, with all of the attendant disadvantages. Granules have not yet become established in this sector.

Liquid colours, on account of their high water content and the hydrophilic nature of the asphalt, and also on account of the high processing temperatures, at which the water would evaporate and disrupt the production process, are not suited to the colouring of asphalt.

### Supply Forms for the Colouring of Emulsion Paints and Plastics:

DE 4 336 612 A1 describes a multi-stage method of preparing inorganic pigment granules from dry pigments by addition of oils, which is similar to the method described in DE 4 336 613 A1. The pigment granules prepared in this way are suitable for colouring plastics and for producing powder coating materials. The method disclosed in DE 4 336 612 A1 has the same disadvantages already stated with regard to DE 4 336 613 A1.

Inorganic pigment granules suitable for colouring plastics or varnishes and also producing aqueous emulsion paints or tinting pastes are also mentioned in DE 179 04 943 A1. It describes inorganic pigment granules, intended among other things for colouring building materials, varnishes and plastics and for producing aqueous emulsion paints, tinting pastes and slurries. The granules comprise one or more water-soluble, hydrophilic or hydrophobic/hydrophilic auxiliaries which are liquid at 25° C., or mixtures of water-soluble, hydrophilic or hydrophobic/hydrophilic auxiliaries, the mixtures being liquid at 25° C., in an amount of 0.1% to 10% by weight. For the preparation of these granules there are a variety of preparation methods specified, including agglomerative granulation and spray drying granulation and also a compacting method.

DE 100 03 248 A1 discloses pigment granules for colouring non-polar media such as asphalt, bitumen, bituminous substances, tar and plastics, produced from a mixture which comprises pigments, at least one agent promoting the colouring and the distribution of the pigment in non polar media, and/or at least one dispersant for polar systems, and also, where appropriate, solvents. The agent promoting the colouring and the distribution of a pigment in non-polar media is to be selected, for example, from the group of waxes. Like DE 197 04 943 A1, DE 100 03 248 A1 also describes a number of preparation methods for granules. These methods, however, are only the methods already mentioned above, such as compression and bricketting methods, granulation by the spray-drying method, fluidized bed granulation or agglomerative granulation.

As already mentioned, DE 103 19 483 A1 discloses a dispersible pigment concentrate which comprises at least one pigment and also, if desired, binders, dispersants and wetting agents, including a disintegration assistant which on contact with water (in sufficient quantity) brings about the substantially complete disintegration of the primary structure of the concentrate within one minute, without mechanical exposure, releasing the pigment. A pigment concentrate of this kind is also said to be suitable for colouring plastics and synthetic resins and for colouring paints, varnishes and the like. Disintegration assistants used include cellulose fibres having a particle size between 10 and 2000 μm. Particles of this kind of size, however, are unsuitable in the context of producing paints, varnishes and plastics.

The disadvantage of pigment granules for colouring plastics lies in their inadequate dispersibility. For this reason pigment granules have to date been unable to establish themselves for the colouring of plastics. The high processing temperatures experienced during the preparation of plastics can lead to the pigment granules sintering together, thereby impairing the dispersing operation. The dispersing effect is then no longer sufficient for the production of high-quality plastics.

Liquid colours are unsuited to the colouring of plastics on account of their high water content and the hydrophobic nature of the plastics, and also on account of the high processing temperatures of the plastics, at which the water would evaporate and disrupt the production process.

Pigment granules for the colouring of paints and varnishes are being very slow to establish themselves. One of the reasons is the almost infinite variety of solvent-borne and solvent-free systems, powder coating materials, and so on. The production of granules requires the addition of auxiliaries of some sort. It is known, however, that auxiliaries which in one system (combinations of binders, fillers, solvents and additives) lead to very good dispersibility or to an improvement in product properties may be far less effective in another system, and in certain circumstances an incompatibility may even be observed. Thus, for example, hydrophobic auxiliaries which are advantageous when incorporated into solvent-borne varnish systems lead to difficulties when incorporated into aqueous emulsion paints, since the granules are wetted only very poorly by water. For this reason, in the field of paints and varnishes, it would be needed to prepare and offer tailor-made granules for every application medium, with the auxiliaries optimum for that medium. Only for water-based systems have recent years seen the offering on the market of granules having good dispersing properties. Thus, for example, Lanxess Deutschland GmbH, with LEVANYL® Gran and LEVANOX® Gran, offers a range of self-dispersing, solvent-free, organic and inorganic pigment preparations in microgranular form. These products are suitable for numerous water-based systems, such as paints, detergents or jointing mortars, for example. The additive fraction in these products, however, is very high. They are therefore no longer pure pigment granules, but instead must be considered as solid pigment formulations in a ready-to-use form. Similar considerations apply to the stir-in pigments from BASF AG which are known under the Xfast™ name. These stir-in pigments are in granulated form and are ready to use, so that the paint is dispersed rapidly and uniformly when incorporated with stirring. These products also have a very high additive fraction, generally of more than 20% and often indeed up to 30%, and should therefore also be considered ready-to-use solid pigment formulations. They are mostly employed only for water-based paint and varnish systems.

### Supply Forms for Colouring Paper:

Even today, powder pigments are still used exclusively for the colouring of paper. The reason is that, apart from the powder, all other supply forms contain added auxiliaries of some kind. These auxiliaries interfere with the otherwise very demanding process of papermaking. For the most part, therefore, the pigments in powder form are used directly for paper colouring. In exceptional cases the on-site slurries are also used, where the pigment powder is first suspended in water on site before being used for the colouring operation.

In principle, the market requires two divergent properties of pigment granules, irrespective of the preparation method from which they originate. These two properties are as follows: mechanical stability on the part of the granules, and good dispersing properties in the medium employed. The mechanical stability is responsible for good transport properties both in transit between manufacturer and user, and also for effective metering and flow properties when the pigments are used. It is brought about by means of high adhesion forces and is dependent, for example, on the quantity and identity of the binder. The dispersibility, on the other hand, is influenced by effective grinding prior to granulation (wet and dry grinding) by the mechanical energy accompanying the incorporation of the pigment into the respective application medium (shearing forces), and by dispersing assistants, which immediately lower the adhesion forces in the granules when they are incorporated into a medium. Obtaining the optimum colour requires that the pigment granules be disrupted to form primary particles. In the case of inorganic pigments, the application of extensive amounts of dispersing assistants is restricted owing to the auxiliary/pigment cost ratio. Moreover, a high fraction of auxiliaries results in a corresponding reduction in colour strength and/or scattering power.

Furthermore, in the case of all supply forms for which auxiliaries of some sort are added, such as granules or liquid colour, for example, the additions ought not to adversely alter the service properties of the end products they are used to colour, in other words building materials, asphalt, plastics, paints and varnishes—for example, in the case of concrete, the compressive strength or the solidification behaviour; in the case of asphalt, the compressive strength or abrasion resistance; in the case of plastics, the strength or notched-impact toughness; in the case of elastomers (polymers), the elastic properties; and, in the case of paints and varnishes, the rheological properties.

It was an object of the present invention, in addition to the known solids supply forms for inorganic pigments, such as powders or granules, and in addition to liquid colour as a liquid supply form, to provide a completely new supply form for both organic and inorganic pigments, this new supply form being dust-free, not having the disadvantages of liquid colour, being suitable for colouring a variety of application media, and additionally being easy to prepare.

### SUMMARY OF THE INVENTION

This object has been achieved by means of a pigment preparation for colouring lime-bound and/or cement-bound building materials, asphalt, paints, varnishes, paper or plastics, comprising
one or more organic and/or inorganic pigments dispersed in a liquid; and
if desired, further auxiliaries and/or fillers;
   the pigment preparation
being of pasty or gellike consistency; and
not tending towards phase separation.

Lime-bound and/or cement-bound building materials for the purposes of this invention include concrete, cement mortar, plaster and sand-lime brick. The generic term asphalt encompasses asphalt, bitumen, all bituminous substances, and tar.

### DETAILED DESCRIPTION OF THE INVENTION

One of the features of the pigment preparation of the invention is that one or more organic and/or inorganic pigments are in dispersion in a liquid. In this case it is possible to use polar liquids or polar liquid mixtures, in other words mixtures of at least two polar liquids. The liquid used includes water or a water-miscible liquid or a mixture of at least two water-miscible liquids. Since the use of polar liquids such as water is disadvantageous when, for example, colouring non-polar plastics or asphalt, the pigment preparation of the invention may also comprise non-polar liquids or non-polar liquid mixtures, in other words mixtures of at least two non-polar liquids, in which the organic and/or inorganic pigments are in dispersion. The liquid used includes a water-immiscible liquid or a mixture of at least two water-immiscible liquids.

The organic and/or inorganic pigments dispersed in a liquid in the pigment preparation of the invention may be both chromatic and achromatic pigments (black pigments and white pigments). Inorganic pigments used include iron oxide, titanium oxide, chromium oxide, zinc oxide and rutile mixed phase pigments and carbon black (carbon pigments) or mixtures thereof. It is also possible, however, to use fillers. Even the use of metallic lustre pigments or effect pigments is possible. Organic pigments used include azo, quinacridone, phthalocyanine and perylene pigments and indigoids or mixtures thereof. The use of one or more inorganic pigments in a blend with one or more organic pigments is also conceivable.

The pigment preparation of the invention can have a pigment content of at least 15% by weight, for example at least 25% by weight. The maximum possible pigment content is dependent on the liquid used and on the type of pigment employed. The morphology of the pigment particles and their size and surface nature is significant. The coarser the pigment, in other words the larger the primary particles of the pigment the higher the maximum possible solids contents. Pigment contents of up to 70% or more are possible.

The pigment preparation of the invention is of pasty or gellike consistency. A pasty consistency for the purposes of this invention means a very viscous or semi-solid or doughy, kneadable or easily deformable mass which does not retain its shape. A gellike consistency for the purposes of this invention is a solid and easily deformable or kneadable composition which retains its shape.

The pasty or gellike consistency of the pigment preparation can be brought about through the addition of at least one thickener and/or at least one thickener in combination with one or more compounds which together increase firmness.

The consistency of the pasty or gellike pigment preparation may still change after it has been prepared. If the pigment preparation is dispensed immediately after being prepared and is not moved anymore for a few days, it often undergoes an increase in its firmness. This is possibly because the network structures and/or the hydrogen bonds, and also their interplay within the pigment preparation, are able to form only over the course of time, and may be disrupted by external mechanical events. For this reason the consistency of the pigment preparation should be assessed not immediately after it has been prepared but instead at the earliest after a 24-hour storage period.

Thickeners used may be both organic and inorganic thickeners. The activity of thickeners may derive from various effects, such as, for example, swelling, gelling, micelle association, solvation, formation of network structures and/or hydrogen bonds, and their interplay. The thickeners influence the consistency of the pigment preparation. This occurs through the increase in the viscosity, through development of a gel structure and also, where appropriate, through a reduction in the surface tension. Those thickeners capable of developing a gel structure can be used.

Organic thickeners such as organic natural thickeners, organic modified natural materials, organic all-synthetic thickeners, organic associative thickeners or low molecular mass organic products are, for example, used. The organic natural thickeners include, for example, agarose, agar-agar, carrageenans in the iota, kappa or lambda form, tragacanth, gum arabic, algin, pectins with a high or low degree of esterification, polyoses, guar flour, carubine (carob bean flour), tara flour, karaya, gellan, xanthan, starch, starch phosphates, dextrin, gelatines or casein. Algin should be considered a collective term for all polysaccharidic constituents from the cell walls of brown algae. These include alginic acid and its salts, the alginates, and also the derivatives of alginic acid. The commercial products are usually called alginates. Agarose or agar-agar, also called just agar for short, comprehends polysaccharidic constituents from the cell walls of various red algae. Agar agar is a mixture of two fractions: the agarose, which has a gelling effect and is present at up to 70%, and the non-gelling agaropectin, at up to 30%. The carrageenan designation comprehends carrageenan and also the semi-synthetic products which contain only one kind of ion and are often referred to as carrag(h)eenates. The three terms are synonymous.

Further details will now briefly be given of some of the organic natural thickeners and their properties.

Agar is insoluble in cold water; when heated it dissolves and gels on cooling in a similar way to carrageenan, the imaged picture likewise being the formation of a three-dimensional network by means of double helices and helical associations. The gels acquire their stability solely through hydrogen bonds. Agar gels in just a 0.5% strength aqueous solution, independently of cations. The gels are stronger than carrageenan gels and are thermoreversible. However, they exhibit a very strong hysteresis—that is, a difference exists between the softening temperature and the gelling temperature of the gel. The gelling point is at 45° C., whereas melting requires heating to 90° C.

In the case of carrageenan a distinction is made essentially between three main constituents: kappa, iota and lambda carrageenan. Further carrageenan types, likewise identified by Greek letters, such as alpha, beta, pi or omega carrageenan, for example, will not be dealt with in any more detail here. In the case of carrageenan the strength of the gel is brought about by means of a double helix structure. For kappa carrageenan and iota carrageenan it is known that the diequatorial glycosidic linkages afford the possibility, as hot solutions cool, for the formation of double helices. In this way, adhesion zones are formed and a three-dimensional network comes about: a gel is formed. On heating, the helices unfold again, to give, once again, a random interentanglement of the molecules: the gel melts. The gels containing carrageenan are notable for a low level of hysteresis. In the gel state the helices may undergo association with one another: this implies contraction of the network, and the gel becomes more brittle and exhibits synaeresis. The water gels produced with kappa carrageenan are brittle and tend towards turbidity and synaeresis. This can be avoided by means of mixing with iota carrageenan. Iota carrageenan alone forms clear water gels which exhibit no synaeresis and have a very low hysteresis but are also fairly weak.

Pectins are high molecular mass glycosidic plant constituents which are widespread in fruits, roots and leaves. The pectins are composed essentially of galacturonic acid units, with 20% to 80% of their acid groups esterified with methanol. Among the pectins a distinction is made between highly esterified pectins, with a degree of esterification of more than 50%, and low-esterification pectins, with a degree of esterification of below 50%. Quick-gelling pectin (degree of esterification 72% to 74%), normally gelling pectin (degree of esterification 68% to 71%) and slow-gelling pectin (degree of esterification 61% to 68%) are differentiated. The gels of the highly esterified pectins are not heat-reversible. Low-esterification pectins with a degree of esterification of at least 20% require calcium ions for gelling. Calcium pectinate gels are heat-reversible.

Guar flour is a colloidal powder, white to greyish white in colour, which is obtained by grinding the endosperm of the seeds of Cyamopsis tetragonolobus. As a hydrocolloid, guar flour swells in water, but without forming a clear solution, and has approximately eight times the thickening power of starch. Solutions of guar flour have to be preserved.

Carubine (carob bean flour) is the ground endosperm of the seeds of the fruits of the carob tree (Ceratonia siliqua). Carubine is a white to whitish grey powder. In water at 20° C. it is only partly soluble but is fully soluble at 80 to 90° C.

Karaya, also called karaya gum, is a white to brownish powder which swells up to 60 to 100 times its volume in water and forms a viscous mucilage with a strong bonding strength. The viscosity of an aqueous karaya suspension is dependent on pH (not more than pH 7 to 10) and drops sharply in a more acidic or alkali medium.

The physical and chemical properties of tara flour correspond largely to those of guar flour and carubine. Tara flour is not completely soluble in cold water; the solutions possess a significantly higher viscosity than solutions of guar flour or carubine of equal concentration. Like carubine, tara flour gives gels with xanthan, but these gels are weaker and their melting points are lower. Even with agar and carrageenan, tara flour exhibits synergistic gel strengthening.

Gellan gels are stable over a wide temperature and pH range and their firmness can be varied by altering the salt concentration. The substituents, too, influence the gelling capacity: native gellan, esterified with acetate, forms soft gels, whereas the gels of unsubstituted gellan are firm. After heating and cooling, gellan forms thermoreversible gels, the presence of monovalent and divalent cations being needed.

Xanthan is a microbial anionic polysaccharide excreted by Xanthomonas campestris under appropriate culturing conditions. In aqueous solution, xanthan takes on relatively rigid, regular, helical structures. They may be both single helices and double helices. Xanthan dissolves readily in hot and cold water. In that case the helices form a three-dimensional network which gives rise to higher viscosities. Xanthans possess very low temperature dependency, and stability exists over a wide pH range, from 1 to 11.

Representatives of the organic modified natural substances include hydroxyethylcellulose, carboxymethylcellulose, hydroxypropylmethylcellulose, hydroxypropylcellulose, ethylhydroxy-ethylcellulose or other cellulose ethers. Their thickening effect in water is achieved through hydration, formation of intermolecular and intramolecular hydrogen bonds, and interentanglement of the molecule chains.

Organic all-synthetic thickeners may be polyvinyl alcohols, polyacrylic acids and polymethacrylic acids and their salts, polyacrylamides, polyvinylpyrrolidone, polyether glycols, styrene-maleic anhydride copolymers and also their salts. The polyacrylic acids and polymethacrylic acids and their salts also include the copolymers and terpolymers of acrylic acid and methacrylic acid. These thickeners are available in the form of an aqueous solution or an acidic emulsion and undergo transition to highly viscous solutions only when neutralized.

Organic associative thickeners can also be used. These differ from the abovementioned organic modified natural materials and the organic all-synthetic thickeners in that as well as water-solubilizing hydrophilic groups they also contain hydrophobic end groups or side groups in the molecule. This gives associative thickeners the nature of surfactants, and an ability to form micelles. Examples of associative thickeners that may be mentioned include the following: hydrophobically modified polyacrylates, which contain non-ionic hydrophilic and hydrophobic groups incorporated into an anionic acrylate thickener molecule; hydrophobically modified cellulose ethers, which contain long-chain alkyl epoxides or alkyl halides incorporated into a cellulose ether molecule; hydrophobically modified polyacryamides; hydrophobically modified polyethers; or associative polyurethane thickeners, which are composed of hydrophilic polyether segments, linked via urethane groups and of relatively high molecular mass, which are capped with at least two terminal hydrophobic molecule groups. The associative thickeners can be used with advantage in particular when there are hydrophobic, water-immiscible liquids present in the pigment preparation of the invention. Examples of organic products of low molecular mass which may act as thickeners are metal soaps, hydrogenated castor oil, modified fatty derivatives or polyamides. Metal soaps can include metal soaps derived from organic carboxylic acids having 8 to 22 carbon atoms, for example having 12 to 18 carbon atoms, such as zinc stearate, magnesium stearate, lithium stearate, zinc laurate or magnesium myristate.

Thickeners used include inorganic thickeners. Inorganic thickeners may be, for example, silicas or polysilicas. For aqueous or hydrophilic systems suitability is also possessed by phyllosilicates, which in water, in the presence of sufficient shearing forces and in a suitable pH range, lead to the construction of pasty or gellike structures. A significant subgroup of the phyllosilicates are the smectites, with the subgroups montmorillonite and hectorite. By treatment with quaternary ammonium compounds, hydrophobic organophyllosilicates are formed from hydrophilic smectites, and are then suitable for organophilic systems. Organophyllosilicates can be used with advantage particularly when hydrophobic and water-immiscible liquids are present in the pigment preparation of the invention.

Two or more thickeners which in combination with one another possess a synergistic effect and reinforce their thickening action can also be used. Examples of thickeners which in combination with one another possess a synergistic effect include only the combinations of xanthan with dextrin and, in particular, with galactomannans, such as carubine, guar flour and tara flour, for example. With carubine, for example, xanthan forms strong, rubber like and thermoreversible gels. It is assumed that in the case of xanthan, similar to what is the case with carrageenan and agar, a double helix structure is developed which is responsible for the pronounced plasticity and yield point. By means of the smooth segments of galactomannan molecules, the double helices are connected to form a three-dimensional network. Of particular interest is the synergistic effect between kappa carrageenan and carubine. If part of the carrageenan is replaced by carubine, which itself does not gel, the gel then becomes stronger and its properties are improved: it becomes more elastic and has much less of a tendency towards turbidity and synaeresis. Agar too shows a synergism with carubine.

It is possible to increase firmness of the pigment preparation with its pasty or gellike consistency by adding one or more compounds. At least one thickener can be used in combination with one or more compounds which together increase firmness, in an overall amount from 0.001% to 10% by weight, for example from 0.1% to 5% by weight, based on the pigment preparation. Thus it is known that numerous polyhydroxy compounds such as polyvinyl alcohols or polysaccharides such as carubine, for example, in combination with small amounts of borax or borates, tend towards a sharp increase in viscosity and, finally, gelling. This effect occurs not only in water but also, for example, in formamide. Among the pectins a distinction is made between highly esterified pectins, with a degree of esterification of more than 50%, and low-esterification pectins, with a degree of esterification of below 50%. In the case of the highly esterified pectins, there are associations in sub-regions of the pectin chain, as a result of formation of hydrogen bonds, thereby forming a three-dimensional network. The irregularities in the molecule produce only short points of adhesion. Stabilizing them necessitates lowering the activity of the water and reducing the dissociation. Both are accomplished by addition of sugar (sucrose, for example) and acid (fruit acids, for example, such as citric acid or malic acid). The higher the degree of esterification, the quicker the pectin tends towards gelling. Low-esterification pectins, with a degree of esterification of at least 20%, require calcium ions for gelling, which with the carboxyl groups and hydroxyl groups of the galacturonic acid units, linked by axial-axial bonds, form associations of chains. The calcium ions must remain in deficit and should react only slowly with the pectin molecule. This slow reaction is achieved by using insoluble calcium salts such as citrate or phosphate. Amidated pectins occupy a middle position. They require calcium ions for gelling, but do not tend towards coagulation in the event of excess calcium. With algin as well, a large part is played by cations in the context of gelling. Even small amounts of calcium ions may sharply increase the viscosity, as a result of formation of complexes. The sensitivity towards calcium ions in this case is much higher than in the case of pectins, probably on account of the higher degree of polymerization. The adhesion sites are stronger than in the case of pectin. In contrast to pectin, calcium alginate gels are not heat-reversible, even in the absence of sugar. In the case of carrageenan, the strength of the gel is brought about as a result of a double helix structure. In this case the presence of cations has a very substantial influence on the strength of the gel. A kappa-rich carrageenan product mixture of 0.2% of potassium salt, at concentrations of just 0.5%, produces a solid gel from water, with a gelling point of about 40° C. and a melting point of about 55° C. The strength of the water gel climbs sharply as the potassium ion concentration goes up. The addition of sugar likewise increases the gel strength. These additions increase not only the gelling temperature but also the melting temperature of the gels; in any case, however, the hysteresis, in other words the difference between the softening temperature and the gelling temperature of the gel, remains low and is between 10 and 15° C.

Thickeners used include alga 1 extracts such as agar agar, carrageenans in the iota, kappa or lambda form, alginates such as sodium alginate or calcium alginate, exudates of microorganisms or plants, such as xanthan and its derivatives, gellan, gum arabic, tragacanth, karaya gum or ghatti gum, endosperms of the seeds of fruits or plants, such as guar flour, carubine or tara flour, fruit extracts such as pectins, thickeners of animal origin such as protein derivatives and gelatines from cattle, pigs, fish and also caseinates, or mixtures of these compounds.

The compound or compounds used which in combination with at least one thickener together increase firmness is or can be, respectively, carbonates, hydrogen carbonates, sulphates, glycerol phosphates, borates, chlorides, nitrates, phosphates, acetates, hydroxides of monovalent, divalent or trivalent metal salts and also the salts of α-hydroxy acids (citrates, tartrates, lactates and malates) or of fruit acids or else the salts of amino acids (aspartate, arginate, glycocholate and fumarate) and can include salts of the alkali metals and alkaline earth metals, particularly sodium, potassium, magnesium, calcium or strontium salts, such as sodium nitrate, potassium nitrate, magnesium nitrate, calcium nitrate, strontium nitrate, sodium borates, potassium borates, calcium borates, magnesium borates, sodium chloride, potassium chloride, magnesium chloride, calcium chloride, strontium chloride, sodium sulphate, potassium sulphate, magnesium sulphate, calcium sulphate, calcium phosphate, magnesium acetate, calcium acetate or mixtures of these salts. The amount of the compound or compounds can be situated in the range from 0.001% to 3% by weight, for example in the range from 0.1% to 1.5% by weight, based on the total weight of the pigment preparation.

Not only salts can increase firmness in combination with a thickener. The same effect is also known of molecular compounds: consequently molecular compounds which in combination with a thickener increase firmness can also be used. As already mentioned, highly esterified pectins may form a three-dimensional network by means of hydrogen bonding. The irregularities in the molecule, however, mean that the adhesion sites are short. Additional stabilization may be achieved through the addition of sugar (for example sucrose). In the case of carrageenan gels as well, sugar can be added to increase the gel strength. Agarose gels likewise obtain their stability solely through hydrogen bonds. Additional stabilization is achieved, for example, by crosslinking with 2,3-dibromo-1-propanol.

As compounds which in combination with a thickener increase firmness it is possible to use not only salts and molecular compounds but also complex compounds of metals. Complexes of elements of transition groups IV to VI of the Periodic Table of the Elements, more particularly of titanium, vanadium and chromium can, for example, be used.

The amount of the compound or compounds which in combination with a thickener increase firmness can be situated in the range from 0.001% to 3% by weight, for example in the range from 0.1% to 1.5% by weight, based on the total weight of the pigment preparation.

Thickeners used include fully hydrolysed polyvinyl alcohols and also their derivatives or other polyhydroxy compounds in combination with boron compounds, such as ortho-boric acid, tetra-boric acid, meta-boric acid or their salts, or in combination with salts or complexes of elements of transition groups IV to VI of the Periodic Table of the Elements, such as of titanium, vanadium and chromium, such as titanium(III) salts or titanium(IV)-triethanolamine, where appropriate with the pH set to neutral or slightly alkaline. As well as the various boric acids or their salts, and also boric anhydride or fluoroboric acid, organic boron compounds such as boric esters or complexes of boron trifluoride with, for example, dimethyl ether, propanol or acetic acid can be used.

The regularly arranged hydroxyl groups in the polyvinyl alcohol chains are capable with certain substances of forming complex compounds or associations which in chemical terms are more or less stable and which, depending on the concentration in which they are admixed, increase the viscosity of the polyvinyl alcohol solution possibly even as far as gelling. The classic example of complex formation with polyvinyl alcohol is its reaction with boric acid on the one hand and with salts of boric acid on the other. The reaction with boric acid produces a monodiol complex. The viscosity of solutions of these monodiol complexes depends primarily on the chain length and on the degree of hydrolysis of the polyvinyl alcohol. The situation is different when a polyvinyl alcohol solution is exposed to salts of boric acid or to a solution containing boric acid when the pH is shifted into the alkaline. In this case, as a polyelectrolyte, the polyvinyl alcohol-boric acid monodiol complex forms the polyvinyl alcohol-boric acid didiol complex, in which two polyvinyl alcohol chains are linked to one another via boric acid. For this case, however, structures with ionic bonding are conceivable as well. Besides ortho-boric acid, tetra-boric acid, meta-boric acid or their salts, or boric anhydride or fluoroboric acid, organic boron compounds can be used as well, such as boric esters or complexes of boron trifluoride with, for example, dimethyl ether, propanol or acetic acid.

The viscosity of polyvinyl alcohol solutions can be increased not only with boric acid and its salts but also with complex-forming compounds of the elements of the transition groups IV to VI of the Periodic Table of the Elements. In certain circumstances this increase in viscosity goes as far as the gelling of the solution. In many cases the complex which forms can be fixed thermally. With polyvinyl alcohol solution, the titanium(IV)-triethanolamine complex yields highly viscous to gelling titanium(IV) complexes. The increase in viscosity induced by this complex is largely independent of pH. Similarly, titanium sulphate as well reacts with polyvinyl alcohol solution to form a titanium(IV)-polyvinyl alcohol complex. Titanium(III) compounds, vanadium compounds and chromium compounds, even at low concentrations, bring about gelling of the polyvinyl alcohol solution. Organic compounds may likewise lead to an increase in the viscosity of polyvinyl alcohol solutions. The acetalization of polyvinyl alcohol as well, for example with formaldehyde and acid (as catalyst), can be included in this consideration. Small amounts lead to a thickening of the polyvinyl alcohol solution, possibly to the point of gelling. Stopping the acetalization reaction with aqueous alkali fixes the consistency of the mixture at the point it has reached. Gels can also be prepared by acetalizing polyvinyl alcohol with difunctional aldehydes such as glyoxal or glutaraldehyde, with acidic catalysis. Polyhydric phenols and related compounds such as resorcinol, pyrocatechol, phloroglucinol, gallic acid, salicylanilide and 2,4-dihydroxybenzoic acid can form relatively loose complexes (associations) with polyvinyl alcohols. These associations are thermally reversible—that is, it is possible to prepare gels which become liquid at an elevated temperature and resolidify on cooling.

An increase in viscosity possibly to the point of gelling of the polyvinyl alcohol solution occurs with the substances identified above even when one or more organic and/or inorganic pigments are in dispersion in the polyvinyl alcohol solution. Polyvinyl alcohols or their derivatives are suited to preparing the pigment preparations of the invention. The pasty or gellike pigment preparations prepared, starting from water, with addition of partly or fully hydrolysed polyvinyl alcohols in combination with ortho-boric acid, tetra-boric acid, meta-boric acid or their salts are distinguished by a number of outstanding performance properties: the consistency of the pigment preparations can be varied over a very wide range through the chain length, the concentration and the degree of hydrolysis (degree of saponification) of the polyvinyl alcohol and also by way of the amount of added boric acid or its salts or of the added complex-forming compounds of the elements of transition groups IV to VI of the Periodic Table of the Elements. A pigment preparation can be prepared which has a very soft, pasty and stringing consistency, or else a pigment preparation having a decidedly hard and rubber-elastic consistency. Apart from partly or fully hydrolysed polyvinyl alcohols, use is also made of other polyhydroxy compounds in combination with ortho-boric acid, tetra-boric acid, meta-boric acid or their salts. Such compounds include, for example, polysaccharides based on mannans, galactomannan, such as carubine, polymannuronic acid, polygalacturonic acid, rhamnose, galactose, galacturonic acid, arabinose, xylose, glucuronic acid, mannose, glucose or galactan. It is unimportant whether these polysaccharides are in the form of linear, branched or highly branched macromolecules. The stated polyhydroxy compounds occur in nature, as for example in the seeds of Ceratonia siliqua (carubine), Medicago sativa, Gleditsia triacanthus, Trigonella foenum graecum, Cyamopsis tetragonolobus (guar flour) or Lupinus albus. They also occur in nature in the form of mucilage, as for example in the form of mucilage from the bark of Ulmus fulva or in the form of mucilage from Linum usitatissimum or from Tamarindus indica. They may also occur in nature in the form of gum, as for example in the form of cherry gum (Prunus avium) or gum Arabic.

Many thickeners or gel formers act not only in water but also in other polar solvents. For example, highly esterified and low-esterification pectins and also the alkali metal salts of pectic acid dissolve not only in water but also in dimethylformamide, dimethyl sulph oxide and hot glycerol. Polysaccharides which gel in aqueous solution with borax also exhibit this phenomenon in formamide. Gelatine too dissolves in ethylene glycol, glycerol and formamide.

Where appropriate the pigment preparation of the invention may also comprise further auxiliaries. Auxiliaries used include salts from the group of the phosphates, phosphonates, carbonates, sulphates, sulphonates, silicates, aluminates, borates, titanates, formates, oxalates, citrates, tartrates, stearates, acetates, polysaccharides such as celluloses, cellulose derivatives, such as cellulose ethers or cellulose esters, phosphonocarboxylic acids, modified silanes, silicone oils, oils from biological cultivation (such as rapeseed oil, soybean oil, maize germ oil, olive oil, coconut oil, sunflower oil), refined petroleum oils with a paraffinic and/or naphthenic basis, synthetically produced oils, alkylphenols, glycols, polyethers, polyglycols, polyglycol derivatives, ethylene oxide-propylene oxide copolymers, protein-fatty acid condensation products, alkylbenzenesulphonates, alkylnaphthalenesulphonates, lignosulphonates, sulphated polyglycol ethers, melamine-formaldehyde condensates, naphthalene-formaldehyde condensates, gluconic acid, polyacrylates, polycarboxylate ethers, polyhydroxy compounds, polyhydroxyamino compounds or solutions or mixtures or suspensions or emulsions of these.

Auxiliaries used include wetting agents and/or dispersing additives and/or emulsifiers and/or preservatives and/or defoamers and/or retention agents and/or anti-settling agents and/or fragrances.

Suitable wetting agents include alkylbenzenesulphonates, fatty alcohol sulphates, fatty alcohol ether sulphates, fatty alcohol ethoxylate, alkylphenol ethoxylate, branched and/or unbranched alkanesulphonates or olefinsulphonates, branched and/or unbranched alkane sulphates or olefin sulphates and sulphosuccinates.

Dispersing additives used include lignosulphonates, melaminesulphonates, naphthalenesulphonates, soaps, metal soaps, polyvinyl alcohols, polyvinyl sulphates, polyacrylamides, polyacrylates, polycarboxylate ethers, medium- and long-chain alkane sulphates or alkanesulphonates or alkane sulphosuccinates, and also medium- and long-chain alkane phosphates or alkanephosphonates.

Suitable emulsifiers include emulsifiers having HLB values of 7 to 40, for example 8 to 18, for use in building materials with aqueous systems such as concrete, for example, containing alkyl radicals or acrylic radicals and hydrophilic pendent groups and end groups such as, for example, amides, amines, ethers, hydroxyl, carboxylate, sulphate, sulphonate, phosphate, phosphonate, amine salt, polyether, polyamide, polyphosphate. The substances may be used individually or in combination in accordance with their HLB value.

Preservatives that may be mentioned include, by way of example, formaldehyde donor compounds, phenolic compounds or isothiazolinone preparations. Adding such preservatives is often advisable, since numerous organic thickeners are sensitive to microbial attack and can be stabilized by addition of preservatives.

Furthermore, defoamers are also employed. Defoamers are substances which are intended to prevent the formation of foam. They act by forming a closed film at the interface of the pasty or gellike pigment preparation with air, and so allow the medium in which degassing/defoaming is desired to develop a relatively small surface area within a very short time, with destruction of the gas bubbles, and hence to form a relatively low-energy state. Defoamers often derive from natural fats and oils or else are petroleum derivatives, modified silicone oils or modified polyethers.

Substances identified as fragrances are all those which have a more or less strong odour and stimulate the human sense of smell. Fragrances which stimulate the human sense of smell in a pleasing or exciting way can also be used. Fragrances can include, for example, natural, semi-synthetic or all-synthetic origin, the naturally occurring fragrances hailing from plant or animal sources. The fragrances can be used individually or in combination with one another.

The auxiliaries can be used in a total amount from 0.001% to 10% by weight, for example from 0.05% to 5% by weight, based on the pigment preparation.

The pigment preparation of the invention does not tend towards phase separation over an extended period such as of at least two months, for example, at least six months. In other words, during this time, the liquid phase does not separate out of the pasty or gellike pigment preparation. In the case of a gel this phenomenon is referred to as synaresis. In synaresis, the liquid phase comes out of a gel without its structure collapsing. This is also referred to as exudation. Accordingly, the pasty or gellike pigment preparations of the invention remain unchanged over a period of at least two months, for example for at least six months. The method of ascertaining whether a pasty or gellike pigment preparation that has been prepared tends towards phase separation by separating out the liquid phase is elucidated under heading I.4 in the section concerning the “Description of the Measuring and Testing Methods used”.

The pigment preparation exhibits, for example, only a low colouring effect—and more particularly none at all—on dry and smooth surfaces, such as metal, glass, ceramic, textiles or plastics, for example. As elucidated under heading I.3 in the section concerning the “Description of the Measuring and Testing Methods used”, the average increase in mass of the bolt is, for example, not more than 0.15 g, or not more than 0.12 g or not more than 0.07 g.

The method of ascertaining whether a pasty or gellike pigment preparation that has been prepared exhibits no colouring effect on dry and smooth surfaces takes place with the aid of a bolt made from bright-drawn V4A round steel (material 1.4571) and is elucidated under heading I.3 in the section concerning the “Description of the Measuring and Testing Methods used”. On dry and smooth skin as well the pigment preparation, given a choice of the appropriate thickeners and auxiliaries, exhibits only a low colouring effect or, for example, none at all. The pasty or gellike pigment preparations can be held and kneaded in the hand. Even under pressure they exhibit no colouring effect on the dry internal surfaces of the hand. Any remainders that do adhere can be removed easily and generally without residue from the surface in question. It is presumed that the intermolecular forces which act within the pasty or gellike pigment preparation and are responsible for the formation of the network structures and/or the hydrogen bonds in its interior are stronger than the forces of adhesion that the pigment preparation is able to develop to smooth and dry surfaces such as metal, glass, ceramic, textiles or plastics. The pigment preparation of the invention therefore not only is dust-free but also can be handled cleanly and without problems. Only on moist surfaces there may possibly be some staining, owing to the beginning of breakdown of the pasty or gellike pigment preparation.

The pigment preparation can further comprises at least one filler in an amount of not more than 40% by weight, for example, not more than 10% by weight, based on the pigment preparation. By fillers are meant colourless inorganic or synthetic, lamellar or non-lamellar particles which are able to provide the pigment preparation with additional thickening and are intended to endow it with hardness, smoothness, mattness or lustre. The fillers can be selected from talc, mica, silicas, kaolin, nylon powders, poly(β-alanine) powders, polyethylene powders, Teflon, lauroyllysine, boron nitride, bismuth oxychloride, polytetrafluoroethylene powders, polymethyl methacrylate powders, polyurethane powders, polystyrene powders, polyester powders, synthetic hollow microspheres, microsponges, silicone resin microspheres, the oxides of zinc and titanium, the oxides of zirconium and cerium, precipitated calcium carbonate or chalk magnesium carbonate, magnesium hydrogen carbonate, hydroxyapatite, hollow silica microspheres, microcapsules of glass or of ceramic, metal soaps derived from organic carboxylic acids having 8 to 22 carbon atoms, such as having 12 to 18 carbon atoms, for example, zinc stearate, magnesium stearate, lithium stearate, zinc laurate and magnesium myristate, the compounds SiO₂/TiO₂/SiO₂, TiO₂/CeO₂/SiO₂ or else TiO₂/ZnO/talc and also the polyethylene terephthalate/polymethacrylate polymers in the form of platelets.

The invention also provides a method of preparing a pigment preparation, characterized in that
to a dispersion of one or more organic and/or inorganic pigments in a liquid which if desired also comprises further auxiliaries and/or fillers, and
before, during or after the dispersing operation, at least one thickener and/or at least one thickener in combination with one or more compounds which together increase firmness is added and
the pasty or gellike pigment preparation is homogenized for a sufficiently long time, and
where appropriate, finally, further auxiliaries are added.

By a dispersion is meant, in accordance with DIN EN 862: 1995-10, a system (disperse system) made up of two or more phases, of which one is continuous (dispersion medium)—that is, in the sense of this invention, the liquid or liquids—and at least one other is finely dispersed (dispersed phase, dispersoid)—in other words, in the sense of this invention, the organic and/or inorganic pigment or pigments. Since inorganic pigments are insoluble in liquids, the term “suspension” is to be equated with that of “dispersion”.

The addition of at least one thickener and/or at least one thickener in combination with one or more compounds which together increase firmness is made, for example, at room temperature or above room temperature.

Organic or inorganic thickeners can be added.

Organic thickeners used can be partly or fully hydrolysed polyvinyl alcohols and also their derivatives or other polyhydroxy compounds in combination with boron compounds, such as ortho-boric acid, tetra-boric acid, meta-boric acid or their salts, or in combination with salts or complexes of elements from transition groups IV to VI of the Periodic Table of the Elements, such as of titanium, vanadium and chromium, such as titanium(III) salts or titanium(IV)-triethanolamine, where appropriate with the pH set to neutral or slightly alkaline.

The pigment preparation of the invention can be prepared either starting from the dry, solid pigment or else starting from a liquid phase—a dispersion.

In the former case, one or more organic and/or inorganic pigments must first be dispersed in a liquid in order to disrupt the agglomerates of the kind present, for example, in pigment powders or granules. The dispersion of one or more organic and/or inorganic pigments in a liquid can be a redispersion of previously agglomerated particles. The liquid used can be water or a water-miscible liquid or a mixture of at least two water-miscible liquids. Since the use of polar liquids such as water may be disadvantageous in the case, for example, of the colouring of non-polar plastics, it is also possible to use non-polar liquids or non-polar liquid mixtures, in other words mixtures of at least two non-polar liquids. The liquid used can be a water-immiscible liquid or a mixture of at least two water-immiscible liquids.

The use of dry pigments for preparing the pigment preparation of the invention is advantageous when the pigments are obtained via a dry production process. Thus, for example, titanium dioxide pigments, chromium oxide pigments and rutile mixed phase pigments are prepared via calcining processes at high temperatures. The preparation of red iron oxide pigments as well may be accomplished by dewatering of yellow iron oxide or by oxidation of black iron oxide at high temperatures. The dispersing of the solid pigments in a liquid phase may be accomplished, for example, by rubbing the pigment between two surfaces or disrupting the pigment agglomerates by means of impact forces and shearing forces that are generated by discs in high-speed rotation. A combination of these two procedures is also possible. The skilled person is aware of all of the dispersing apparatus that operate in accordance with these principles and is suitable for the dispersing of solid pigments in a liquid phase. Mention may be made at this point merely of roll mills, ball mills, rotor-stator mills, dissolvers, stirred mills and compounders. The stirred mills can be operated as bead mills or sand mills with beads or sand as grinding media, with only one grinding vessel or else in the form of what are called multi-chamber mills or modular mills, with two or more milling vessels, usually connected in series. Compounders in the sense of this invention are all apparatus for mixing viscous, plastic or solid materials to form tough, plastic, doughy, pasty or gellike compositions. The kneading tools of a compounder move relative to one another or relative to stationary surfaces in such a way that there is a high level of compression, division and lamellar displacement of the material being milled. The compounders may be either blade compounders having a double kneading trough with z-shaped kneading blades, or planetary compounders, where the kneading arm(s) or hook(s) perform planetary movements, or screw compounders with single or double screw shafts, or roller compounders. Agitators with a mixing and kneading attachment may also be used. It is not critical to the invention whether the dispersing apparatus operates continuously or discontinuously. Where appropriate it may also be advantageous to perform the dispersing operation with the aid of ultrasound.

Where the starting point is to be a liquid phase, the pigment preparation may be prepared starting from an existing pigment dispersion, of the kind obtained, for example, immediately after actual pigment synthesis or after filtration and washing of the pigment during its work-up and before its drying. The dispersion of one or more organic and/or inorganic pigments in a liquid can be a dispersion originating from the pigment production process.

Numerous inorganic pigments are prepared in aqueous phase. For this reason the pigment dispersion can be an aqueous dispersion from the pigment production process. When using a pigment dispersion from the pigment production process it may be possible—depending on the point at which the pigment dispersion is taken from the pigment production process—to do without the dispersing of the pigment particles, if they are already sufficiently well dispersed. In spite of this it may be advantageous to employ the dispersing apparatus already mentioned above, if the best possible dispersing is required. The use of a pigment dispersion from the pigment production process is particularly advantageous since it allows the energy-intensive and cost-intensive drying of the pigment to be omitted.

When, as a result of the dispersing operation, the organic and/or inorganic pigment or pigments is or are sufficiently well dispersed in the liquid, thickening or gelling takes place, causing an increase in the viscosity of the composition. Before, during or after the dispersing of one or more organic and/or inorganic pigments in a liquid, at least one organic or inorganic thickener and/or at least one thickener in combination with one or more compounds which together increase firmness can be added—where appropriate in portions—in a stirrer, mixer, compounder or dissolver. A large number of stirrers and stirrer mechanisms is described in the prior art. The skilled person will doubtless be able to locate the ideal stirrer or stirrer mechanism for his or her application, capable of thorough stirring of pasty or gelatinous compositions for the purpose of incorporating, sufficiently well and homogeneously, an organic or inorganic thickener and/or at least one thickener in combination with one or more compounds which together increase firmness, into the pigment dispersion as it thickens. The skilled person is also aware of a large number of mixers suitable for thorough mixing of pasty or gelatinous compositions for the purpose of incorporating, sufficiently well and homogeneously, an organic or inorganic thickener or at least one thickener in combination with one or more compounds which together increase firmness, into the pigment dispersion as it thickens. Stirrer mechanisms having a mixing and kneading attachment or to compounders capable of thorough kneading of pasty or gelatinous compositions can be used for the purpose of incorporating, by kneading, sufficiently well and homogeneously, an organic or inorganic thickener and/or at least one thickener in combination with one or more compounds which together increase firmness, into the pigment dispersion as it thickens.

Following the addition—where appropriate in portions—of at least one organic or inorganic thickener and/or of at least one thickener in combination with one or more compounds which together increase firmness, the pasty or gellike pigment preparation can be homogenized in a stirrer, mixer, kneader or roll mill, where appropriate under reduced pressure as well. Operating under reduced pressure allows the inclusion of air bubbles to be prevented. In principle the air bubbles possibly included cause no disruption when the pigment preparation of the invention is used for colouring lime-bound and/or cement-bound building materials, asphalt, paints, varnishes or paper. In the case of the colouring of plastics in extruders, in contrast, included air bubbles can have a disruptive effect. For this specific application it is particularly advantageous to remove the air bubbles beforehand. If the pigment preparation of the invention is of pasty consistency, the air bubbles included often rise to the surface in any case in the course of a few hours or days after its preparation. In other words, the pigment preparation degasses automatically.

The addition of auxiliaries or fillers may in principle be made at any point in time in the production process. They can be added at the beginning of the production process, in other words before or during the dispersing of the organic and/or inorganic pigments in the liquid phase. They can also be added at the end of the production process, by incorporating them then into the pasty or gellike pigment preparation.

The invention also encompasses a method of colouring lime-bound and/or cement-bound building materials, asphalt, paints, varnishes, paper or plastics which is characterized in that the pigment preparation of the invention is mixed with the lime-bound and/or cement-bound building materials, asphalt, paints, varnishes, paper or plastics.

The pigment preparation, before or during its addition to the lime-bound and/or cement-bound building materials, asphalt, paints, varnishes, paper or plastics and/or during the operation of mixing with the lime-bound and/or cement-bound building materials, asphalt, paints, varnishes, paper or plastics, can be liquefied, the liquefaction taking place by
dissolution in one or more liquids and/or
addition of an acid or alkali through a change in pH and/or
chemical reaction, more particularly redox reactions, or enzymatic reaction and/or
supply of heat, mechanical energy and/or ultrasound.

The reliquefication of the pigment preparations of the invention is thus possible in a variety of ways. The pasty or gellike pigment preparations prepared starting from water with addition of partly or fully hydrolysed polyvinyl alcohols in combination with ortho-boric acid, tetra-boric acid, meta-boric acid or their salts exhibit outstanding reliquefaction when incorporated into water with stirring. When the stirred incorporation is performed in the proper art manner, the preparations dissolve in water completely within a short time, usually within just 60 s.

The thickening effect and/or the gelling properties of numerous thickeners are dependent on the pH. Consequently the pigment preparations of the invention can also be reliquefied by addition of acid or aqueous alkali, which changes the pH. High acid concentrations and temperatures have the capacity, for example, for quantitative decarboxylation of algin and alginate esters.

The reliquefaction of the pigment preparations of the invention can be accomplished by means of chemical reaction, such as redox reactions, or enzymatic reaction. It is known that 1,2-glycols can be oxidatively cleaved by exposure to periodate. In many polysaccharides this glycol cleavage takes place initially to give the macromolecules. Exposure to potassium periodate then effects the oxidative cleavage of the 1,2-cis-diol moiety that is needed for the formation of a complex with borates. In actual fact, a few minutes after the addition of potassium periodate to a carubine solution, addition of borax produces no further gelling, despite the fact that the viscosity has fallen only a very little as a result of oxidative degradation. The carubine, then, is no longer capable of gel formation. A n existing carubine-borax gel can likewise be reliquefied by titration with potassium periodate. The same reliquefaction effect occurs when solid sodium periodate is merely scattered onto a carubine-borax gel, or a carubine-borax gel is sprayed with a periodate solution.

Not only oxidizing agents which act directly, such as halogens or periodate, but also redox systems such as polyphenols, ascorbic acid or thiol compounds break down algin. To produce alginates of low viscosity, hydrogen peroxide is used. Xanthan is broken down by strong oxidizing agents such as hypochloride or persulphate, particularly at high temperatures. Bacterial alginic acid depolymerases have also been described. Numerous other thickeners—especially when they are of natural origin—can be degraded using enzymes, thereby losing their activity.

As already mentioned, numerous gels can be reliquefied by supply of heat. They are thermoreversible: that is, it is possible to prepare gels which become liquid at elevated temperature and resolidify on cooling. The low-esterification pectins, with a degree of esterification of at least 20%, which require calcium ions for gelling, are heat-reversible in the form of calcium pectinate gels. After heating and cooling, gellan likewise forms thermoreversible gels, the presence of monovalent and divalent cations being needed. Xanthan as well forms strong, rubberlike and thermoreversible gels with carubine. Polyhydric phenols and related compounds such as resorcinol, pyrocatechol, phloroglucinol, gallic acid, salicylanilide and 2,4-dihydroxybenzoic acid may form relatively loose complexes (associations) with polyvinyl alcohols. These associations are thermally reversible.

Rather than supply of heat, the reliquefaction of the pigment preparations of the invention can also be accomplished by supplying mechanical energy, such as by stirring, for example. The supplying of mechanical energy may be advantageous when it is possible to utilize thioxtropic effects in the context of the pigment preparations of the invention. In certain cases the pigment preparation of the invention can also be reliquefied by exposure to ultrasound.

The pigment preparation can be mixed with the lime-bound and/or cement-bound building materials, asphalt, paints, varnishes, paper or plastics in an amount from 0.01% to 15% by weight, for example from 0.1% to 10% by weight, based on the overall mixture.

The pigment preparation of the invention has a series of advantages. It is prepared starting from the liquid phase, thus allowing energy-intensive drying steps to be omitted. This is advantageous, of course, when the preparation of the pigment itself takes place in the liquid phase. The pigment preparation of the invention not only is dust-free but also can be handled cleanly and without problems. Furthermore, it is outstandingly dispersible in the various application media. On account of the pasty or gellike consistency, the pigment preparation of the invention does not exhibit sedimentation. There is no phase separation, and the preparation is stable on storage for a long time period and can be used at any time. It is therefore always ready to use. Furthermore, the pigment preparation of the invention does not exhibit any colouring effect on dry and smooth surfaces. It is presumed that the intermolecular forces which act within such a pigment preparation and are responsible for the formation of the network structures and/or the hydrogen bonds in its interior are stronger than the forces of adhesion that the pigment preparation is able to develop to smooth and dry surfaces such as metal, glass, ceramic, textiles or plastics.

The pasty pigment preparations prepared on the basis of partly or fully hydrolysed polyvinyl alcohols and also their derivatives or other polyhydroxy compounds as thickeners in combination with boron compounds such as ortho-boric acid, tetra-boric acid, meta-boric acid or their salts, or in combination with salts or complexes of elements of transition groups IV to VI of the Periodic Table of the Elements, such as titanium, vanadium and chromium, or such as titanium(III) salts or titanium (IV)-triethanolamine, where appropriate with the pH set to neutral or slightly alkali, are distinguished by further performance advantages. Given a choice of the appropriate chain length, the concentration and the degree of hydrolysis of the polyvinyl alcohol, and also of the correct amount of boron compound and/or of complexing agent, the colouring effect of these pigment preparations on dry and smooth skin is minimal or completely absent. The pigment preparations can be held and kneaded in the hand. Even under pressure they exhibit no colouring effect on the dry internal surfaces of the hand. The extremely strong adhesion forces can also be demonstrated by another phenomenon: a pigment preparation torn into small pieces coalescences again after a short time to give a completely homogeneous composition. Furthermore, these pigment preparations exhibit outstanding reliquefaction when stirred into water. When stirred incorporation is performed in the proper art manner, they dissolve completely within a short time, usually within just 60 s.

In one embodiment the pigment preparation of the invention is gellike and hence retains its shape, so that if the container is damaged there is no leak of product and hence no contamination of the environment or of employees.

The pasty or gellike pigment preparations of the invention can be dispensed readily into large and small containers. The small containers include, for example, tubes, syringes, cartridges, flexible pouches, sealable bags and all other packaging forms known to the skilled person for pasty or gellike products, such as dispensers or the like, for example. Alternatively they can be dispensed into large containers, such as drums, sacks or even bulk bags.

The subject matter of the present invention is apparent not only from the subject matter of the individual claims but also from the combination of the individual claims with one another. The same applies to all of the parameters disclosed in the description and to their combinations of whatever form.

The examples which follow illustrate the invention, without any intention that they should restrict it.

### EXAMPLES

### I. Description of the Measuring and Testing Methods Used

### I.1 Building Material Colour Test

The dispersibility in building materials was tested in cement mortar via the visual assessment of blocks produced using white cement, with the following data:

Cement-quartz sand ratio 1:4, water-cement value 0.35, level of pigmentation 2.4% based on cement, mixer used from RK Toni Technik, Berlin, with 5 l mixing pan, model 1551, rotational speed 140 rpm, batch: 1200 g of quartz sand 0.1 to 1 mm, 600 g of quartz sand 1 to 2 mm, 200 g of finely ground limestone (<5% residue on 90 μm sieve), 500 g of white cement. The quartz sand fractions and the finely ground limestone are charged together to the mixing vessel. They are then premixed for 10 s (mixer setting 1: slow). The pigment preparation in solution in water, in the form of a suspension, or, in the case of the comparative examples, the water-suspended pigment or the water-suspended filtercake, is then added to the initial mixture, ensuring that the total amount of water is 175 g and that the water/pigment suspension is introduced in the middle of the mixture. When the liquid has seeped in, the cement is added and the batch is mixed (mixer setting 1: slow). After a mixing time of 100 s, three 600 g samples are taken and used to produce three specimens (10×10×2.5 cm) under pressure (pressing force: 114 kN for 2 seconds). The specimens are cured to give the completed blocks: for 24 hours at 30° C. and 95% relative humidity, with subsequent drying at 60° C. for 4 hours. The resulting blocks were inspected.

### I.2 Determination of Dispersibility in Emulsion Paints

The dispersibility of chromatic pigments and black pigments in emulsion paints is determined using a dissolver. The test medium employed is an emulsion paint based on a PVA dispersion (vinyl acetate/Versatic acid vinyl ester) having a pigment volume concentration of 55% (pigment/filler ratio 40/60). For the incorporation of the pigment, 180 g of white emulsion paint are introduced initially, and then 6.0 g of the chromatic or black pigment under test—or an amount, converted according to its pigment content, of the pasty or gellike pigment preparation, so that in these cases as well there are 6.0 g of pigment—are added with stirring (titanium dioxide pigment/chromatic pigment weight ratio or titanium dioxide pigment/black pigment weight ratio=5:1, the titanium dioxide pigment used may be, for example, Tronox® R-KB-2, a commercial product of Tronox Inc.). A dissolver disc (diameter 4 cm) is used to set the following dispersing conditions:

| | |
|---|---|
| 10 min | 1000 rpm (2.1 m/s) and then |
| 20 min | 2000 rpm (4.2 m/s) and then |
| 10 min | 4500 rpm (9.4 m/s) |

After the individual dispersing times, a small amount of each paint is removed and used to prepare a drawdown with a wet film thickness of 90 μm (slot height of the drawing bar), which is dried at room temperature. After drying, the drawdowns (coating films) are scraped using a sharp-edged object, allowing the undispersed pigment particles of the chromatic or black pigments to appear at the surface as dots or stripes (bits). The dispersing energy for application to the pigments is assessed by the number of bits present on the individual scrapes, using a scale of evaluation from level 1 to level 5:

| | |
|---|---|
| Level 1: | no bits |
| Level 2: | a few bits |
| Level 3: | moderate bits |
| Level 4: | numerous bits |
| Level 5: | a very large number of bits |

Dispersibility is good only in the case of evaluation levels 1 and 2; at levels 3 and above, the evaluation is insufficient for the dispersing energy employed. The earlier the stage at which evaluation levels 1 or 2 are achieved, in other words the lower the dispersing energy employed, the better the dispersibility of the pigment or pigment preparation under investigation.

### I.3 Testing of the Colouring Effect on Dry and Smooth Surfaces

The colouring effect on dry and smooth surfaces is tested with the aid of a bolt made from bright-drawn V4A round steel (material 1.4571). The bolt possesses a diameter of 8 mm and is 200 mm long. One end is machined to a point over a length of 10 mm, as shown in FIG. 1. Immediately after it has been prepared, the pigment preparation is dispensed into a suitable container which can be given an airtight seal and which in terms of its volume is not substantially larger than the pigment preparation. Such a container may be, for example, an airtightly sealable polyethylene bottle having a sufficiently large aperture, or an airtightly sealable plastic bucket. When filling the container it should be ensured that the fill level within the container is 50 mm. Only when the pigment preparation has cooled to room temperature (20 to 22° C.) is the container in question sealed airtightly and stored at room temperature. After a 24-hour storage period the colouring effect of the pasty or gellike pigment preparation on dry and smooth surfaces is tested. This is done by pressing the clean, dry bolt, with the tip foremost, quickly (suddenly) into the pasty or gellike pigment preparation until the bolt strikes the base of the container. It is then immediately withdrawn again quickly (suddenly) from the pasty or gellike pigment preparation. Differential weighing before and after immersion is used to determine the mass of pasty or gellike pigment preparation adhering to the bolt. The bolt is cleaned and the process is carried out a total of three times, the bolt being immersed into the pasty or gellike pigment preparation at a different location each time. The average increase in mass of the bolt is then calculated from the three weighings. If the average increase in mass of the bolt is not more than 0.07 g, preferably not more than 0.04 g, the pigment preparation exhibits no colouring effect on dry and smooth surfaces in the sense of this invention. In order to demonstrate that an average increase in mass of not more than 0.07 g, preferably of not more than 0.04 g, is very small, comparison will be made with a liquid paint. Bayferrox® 350 liquid (commercial product of Lanxess Deutschland GmbH) is an aqueous suspension of a black iron oxide pigment intended for colouring building materials and having a pigment content of 50% to 55%. The sample of Bayferrox® 350 liquid investigated for the comparison had a pigment content of 53.9% and a viscosity of 1260 mPas (Brookfield viscosity, measured at 20° C. with a No. 4 spindle at 100 rpm). When the test of the colouring effect on dry and smooth surfaces is carried out on such a suspension by the process described, using the bolt, the average increase in mass of the bolt as a result of the pigment suspension adhering to it is 0.73 g.

### I.4 Testing for Phase Separation

Immediately after it has been prepared, the pigment preparation is dispensed into a suitable container which can be given an airtight seal and which in terms of its volume is not substantially larger than the pigment preparation. A container of this kind may be, for example, an airtightly sealable polyethylene bottle having a sufficiently large aperture or an airtightly sealable plastic bucket. Only after the pigment preparation has cooled to room temperature (20 to 22° C.) is the container in question given an airtight seal and stored at room temperature. After a time of at least two months, for example at least six months, a check is made as to whether separation of the phases has occurred, in other words as to whether a supernatant liquid phase has formed on the pigment preparation. Within the container, particularly in the case of wrongly chosen dimensions, there may be a little liquid condensed on the wall or on the lid. Liquid condensation of this kind should not be taken into account

### I.5 Determination of Dispersibility in Water

87.5 g of water are introduced into a 150 ml glass beaker (wide shape). The pasty or gellike pigment preparation is introduced in one piece into the water with stirring using a turbine stirrer (diameter 28 mm) at a speed of 600 rpm. The amount of pasty or gellike pigment preparation added is always chosen such that it contains 6 g of pigment. After a defined period of time the stirrer is shut off, the pigment suspension is tipped through a sieve with a mesh size of 250 μm and the sieve is briefly cleaned with a shower jet. When there are no longer any residues of the pigment preparation on the sieve, in other words when all of the particles of the pigment preparation are smaller than 250 μm, the pasty or gellike pigment preparation is regarded as being fully dissolved.

### II. Example 1

735 g of chromium oxide green GN (commercial product of Lanxess Deutschland GmbH) and 735 g of water were used, with addition of 1.52 g of an aqueous solution of sodium polyacrylate with a 40% active compound content, as a wetting and dispersing additive, to produce a dispersion with a pigment content of 50%. Then three drops of Preventol® D6 (commercial product of Lanxess Deutschland GmbH) as a preservative and 38.7 g of pigskin gelatine (240 to 270 g bloom) as a thickener were added, and the dispersion was stirred at 45° C. for 30 minutes. While still hot, the dispersion was tipped into a variety of containers, including children's baking trays, and was cooled to room temperature and given an airtight seal. After around two hours noticeable formation of gel had already occurred. After 24 hours it was possible to invert the baking trays. The pigment preparation obtained had a gellike consistency. The dimensional stability is demonstrated by FIG. 2.

The gellike pigment preparation produced did not exhibit a colouring effect on dry and smooth surfaces in accordance with the testing method described, since the average increase in mass of the bolt was 0.006 g. Moreover, it did not show any phase separation over a period of several months.

The gellike pigment preparation produced was reliquefiable simply by gentle heating to 35° C., with the gel reforming on renewed cooling.

Testing in building materials: 24 g of the gellike pigment preparation were reliquefied with heating and dissolved in 163 g of heated water. When cooled to room temperature, the resulting suspension no longer formed a gel, and was used for the building material colour test described. This resulted in blocks with a homogeneous green colouration.

### III. Example 2

### Comparative Example to Example 1

Testing in building materials: For comparison, 12 g of the chromium oxide green GN powder used for producing the gellike pigment preparation from Example 1 were also dispersed in 175 g of water, with stirring, and used for the building material colour test described. Again, blocks with a homogeneous green colouration were obtained. There was no apparent difference from the blocks coloured using the gellike pigment preparation from Example 1.

### IV. Example 3

550 g of Bayferrox® 330 (black iron oxide pigment, commercial product of Lanxess Deutschland GmbH) were dispersed in 450 g of water. Added to this dispersion were 6.8 g of kappa-carrageenan as a thickener and three drops of Preventol® D6 as a preservative, and the dispersion was stirred at 40° C. for 30 minutes. While still hot, the dispersion was tipped into a variety of containers, including children's baking trays, and was cooled to room temperature and given an airtight seal. After around one hour noticeable formation of gel had already occurred. After 24 hours it was possible to invert the baking trays. The pigment preparation obtained had a gellike consistency. The dimensional stability is demonstrated by FIG. 3.

The gellike pigment preparation produced did not exhibit a colouring effect on dry and smooth surfaces in accordance with the testing method described, since the average increase in mass of the bolt was 0.004 g. Moreover, it did not show any phase separation over a period of several months.

The gellike pigment preparation produced was reliquefiable by heating to 55° C., with the gel reforming on renewed cooling.

Testing in building materials: 24 g of the gellike pigment preparation were reliquefied with heating and dissolved in 163 g of heated water. When cooled to room temperature, the resulting suspension no longer formed a gel, and was used for the building material colour test described. This resulted in blocks with a homogeneous black colouration.

### V. Example 4

### Comparative Example to Example 3

Testing in building materials: For comparison, 12 g of the Bayferrox® 330 powder used for producing the gellike pigment preparation from Example 3 were also dispersed in 175 g of water, with stirring, and used for the building material colour test described. Again, blocks with a homogeneous black colouration were obtained. There was no apparent difference from the blocks coloured using the gellike pigment preparation from Example 3.

### VI. Example 5

550 g of Bayferrox® 330 were dispersed in 450 g of water. Added to this dispersion were 6.8 g of a 1:1 mixture of kappa-carrageenan and iota-carrageenan as thickeners and three drops of Preventol® D6 as a preservative, and the dispersion was stirred at 40° C. for 30 minutes. While still hot, the dispersion was tipped into a variety of containers, including the little bear baking tray from Examples 1 and 3 and was cooled to room temperature and given an airtight seal. After around two hours noticeable formation of gel had already occurred. After 24 hours it was possible to invert the baking trays. The pigment preparation obtained had a gellike consistency and was dimensionally stable.

The gellike pigment preparation prepared was softer than that from Example 3. It did not exhibit a colouring effect on dry and smooth surfaces in accordance with the testing method described, since the average increase in mass of the bolt was 0.013 g. Moreover, it did not shown any phase separation over a period of several months.

The gellike pigment preparation produced was reliquefiable by heating to 45° C., with the gel reforming on renewed cooling.

### VII. Example 6

750 g of chromium oxide green GN were dispersed in a mixture of 500 g of water and 150 g of a 15% strength Mowiol® 18-88 solution as a thickener (Mowiols® are polyvinyl alcohols and are commercial products of Kuraray Specialities Europe GmbH). The dispersion was transferred to an IKA® HKD 2.5 horizontal compounder with DUPLEX blades, and, while it was being kneaded, over a period of approximately 5 minutes, 40 g were added of a room-temperature-saturated potassium tetraborate pentahydrate solution, as a compound which in combination with a thickener together increases firmness. Then kneading and homogenization were continued for 30 minutes more. This gave a pigment preparation of pasty consistency.

The pasty pigment preparation produced did not exhibit any colouring effect on dry and smooth surfaces in accordance with the testing method described, since the average increase in mass of the bolt was 0.00 g. Moreover, it did not exhibit phase separation over a period of several months. When the dispersibility in water was determined in accordance with the process described, it dissolved completely within 60 s.

Testing in building materials: 24 g of the pasty pigment preparation were dissolved with stirring in 163 g of water and the resulting suspension was used for the building material colour test described. The result was blocks with a homogeneous green colouration.

Testing in emulsion paint: 12 g of the pasty pigment preparation produced were used for the above-described determination of dispersibility in emulsion paints. The result was as follows:

| | |
|---|---|
| 10 min at 1000 rpm | evaluation level: 1 |
| 20 min at 2000 rpm | evaluation level: 1 |
| 10 min at 4500 rpm | evaluation level: 1 |

Evaluation level 1 was reached after 10 min at 1000 rpm. Even at the lowest dispersing energy, therefore, the pasty pigment preparation exhibited very good dispersibility.

### VIII. Example 7

### Comparative Example to Example 6

Testing in building materials: For comparisons 12 g of the chromium oxide green GN powder used for producing the pasty pigment preparation from Example 6 were dispersed in 175 g of water, with stirring, and used for the building material colour test described. Again, blocks with a homogeneous green colouration were obtained. There was no apparent difference from the blocks coloured using the pasty pigment preparation from Example 6.

Testing in emulsion paint: For comparison, 6 g of the chromium oxide green GN powder used for producing the pasty pigment preparation from Example 6 were used for the above-described determination of dispersibility in emulsion paints. The result was as follows:

| | |
|---|---|
| 10 min at 1000 rpm | evaluation level: 5 |
| 20 min at 2000 rpm | evaluation level: 4 |
| 10 min at 4500 rpm | evaluation level: 2 |

For the chromium oxide green GN powder, very intense dispersing conditions were selected in order to achieve effective dispersing (evaluation level 2). The chromium oxide green GN powder used, therefore, was much more difficult to disperse than the pasty pigment preparation from Example 6.

### IX. Example 8

The pasty pigment preparation from Example 6 was frozen in an airtightly sealable container at −11° C. for 60 hours. It was then thawed again to room temperature. The rethawed pasty pigment preparation showed no differences from the original pigment preparation. No water had separated out. In the determination of the dispersibility in water in accordance with the process described it still dissolved completely within 60 s.

Testing in building materials: 24 g of the rethawed pasty pigment preparation was dissolved with stirring in 163 g of water and the resulting suspension was used for the above-described building material colour test. The result again was blocks with a homogeneous green colouration. No difference could be found from the blocks from Example 6 and Example 7.

Accordingly the pasty pigment preparation produced had not suffered impairment as a result of the freezing and thawing.

### X. Example 9

1000 g of Bayferrox® 130M (red iron oxide pigment, commercial product of Lanxess Deutschland GmbH) were dispersed in an mixture of 516 g of water, 67 g of a 15% strength Mowiol® 18-88 solution and 83 g of an 8% strength Mowiol® 40-88 solution, in each case as thickeners. The dispersion was transferred to an IKA® HKD 2.5 horizontal compounder with DUPLEX blades, and, while it was being kneaded, over a period of approximately 5 minutes, 30 g were added of a room-temperature-saturated potassium tetraborate pentahydrate solution, as a compound which in combination with a thickener together increases firmness. Then kneading and homogenization were continued for 30 minutes more. This gave a pigment preparation of pasty consistency.

The pasty pigment preparation produced did not exhibit any colouring effect on dry and smooth surfaces in accordance with the testing method described, since the average increase in mass of the bolt was 0.00 g. Moreover, it did not exhibit phase separation over a period of several months. When the dispersibility in water was determined in accordance with the process described, it dissolved completely within 60 s.

Testing in emulsion paint: 10 g of the pasty pigment preparation produced were used for the above-described determination of dispersibility in emulsion paints. The result was as follows:

| | |
|---|---|
| 10 min at 1000 rpm | evaluation level: 1 |
| 20 min at 2000 rpm | evaluation level: 1 |
| 10 min at 4500 rpm | evaluation level: 1 |

Evaluation level 1 was reached after 10 min at 1000 rpm. Even at the lowest dispersing energy, therefore, the pasty pigment preparation exhibited very good dispersibility.

### XI. Example 10

The pasty pigment preparation from Example 9 was frozen in an airtightly sealable container at −11° C. for 60 hours. It was then thawed again to room temperature. The rethawed pasty pigment preparation showed no differences from the original pigment preparation. No water had separated out. In the determination of the dispersibility in water in accordance with the process described it still dissolved completely within 60 s.

Testing in emulsion paint: 10 g of the pasty pigment preparation rethawed were used for the above-described determination of dispersibility in emulsion paints. The result was as follows:

| | |
|---|---|
| 10 min at 1000 rpm | evaluation level: 1 |
| 20 min at 2000 rpm | evaluation level: 1 |
| 10 min at 4500 rpm | evaluation level: 1 |

Evaluation level 1 was reached after 10 min at 1000 rpm. Even at the lowest dispersing energy, therefore, the pasty pigment preparation exhibited outstanding dispersibility. The dispersibility in emulsion paint had not been impaired as a result of the freezing and thawing.

### XII. Example 11

### Comparative Example to Examples 9 and 10

Testing in emulsion paint: For comparison, 6 g of the Bayferrox® 130M powder used for producing the pasty pigment preparation from Example 10 were used for the above-described determination of dispersibility in emulsion paints. The result was as follows:

| | |
|---|---|
| 10 min at 1000 rpm | evaluation level: 5 |
| 20 min at 2000 rpm | evaluation level: 5 |
| 10 min at 4500 rpm | evaluation level: 4 |

The Bayferrox® 130M powder used did not have adequate dispersing properties, since it was not possible to reach evaluation levels 1 or 2. The Bayferrox® 130M powder used, therefore, was much more difficult to disperse than the pasty pigment preparations from Examples 9 and 10 that were produced from it.

### XIII. Example 12

A yellow iron oxide pigment produced by the precipitation method was filtered after synthesis and washed free of salt. The resulting filtercake had a solids content of 51.4%. In a mixture of 242 g of water, 155 g of a 15% strength Mowiol® 18-88 solution and 58 g of an 8% strength Mowiol® 40-88 solution, first of all 1.39 g of Walocel CRT 40000GA (sodium carboxymethylcellulose, commercial product of Wolff Cellulosics GmbH & Co. KG), as an additional thickener, were dissolved. Dispersed in this solution were 973 g of the filtercake, giving a dispersion with a pigment content of 35%. The pigment suspension was transferred to an IKA® HKD 2.5 horizontal compounder with DUPLEX blades, and, in the course of kneading, over a period of approximately 5 minutes, 40 g were added of a room-temperature-saturated potassium tetraborate pentahydrate solution with an active substance content of approximately 40%, as compound which in combination with a thickener together increases firmness. Then kneading and homogenization were continued for 30 minutes more. This gave a pigment preparation of pasty consistency.

The pasty pigment suspension produced did not exhibit any colouring effect on dry and smooth surfaces in accordance with the test method described, since the average increase in mass of the bulk was 0.00 g. Moreover, it showed no phase separation over a period of several months. When the dispersibility in water was determined in accordance with the method described, it dissolved completely within 100 s.

Testing in building materials: 34.3 g of the pasty pigment preparation were dissolved with stirring in 152 g of water and the resulting suspension was used for the building material colour test described. The result was blocks with a homogeneous yellow colouration.

Testing in emulsion paint: 17.1 g of the pasty pigment preparation produced were used for the above-described determination of dispersibility in emulsion paints. The result was as follows:

| | |
|---|---|
| 10 min at 1000 rpm | evaluation level: 1 |
| 20 min at 2000 rpm | evaluation level: 1 |
| 10 min at 4500 rpm | evaluation level: 1 |

Evaluation level 1 was reached after 10 min at 1000 rpm. Even at the lowest dispersing energy, therefore, the pasty pigment preparation exhibited very good dispersibility.

### XIV. Example 13

### Comparative Example to Example 12

Testing in building materials: For comparison, 23.3 g of the filtercake used for producing the pasty pigment preparation from Example 12 were dissolved in 163.7 g of water, with stirring, and the resulting suspension was used for the building material colour test described. Again, blocks with a homogeneous yellow colouration were obtained. These blocks, however, were substantially less brilliant in comparison to those from Example 12, owing to the much lower yellow tint.

Testing in emulsion paint: For comparison, 11.7 g of the filtercake used for producing the pasty pigment preparation from Example 12 were used for the above-described determination of dispersibility in emulsion paints. The result was as follows:

| | |
|---|---|
| 10 min at 1000 rpm | evaluation level: 5 |
| 20 min at 2000 rpm | evaluation level: 5 |
| 10 min at 4500 rpm | evaluation level: 4 |

The filtercake used was not sufficiently dispersible, since it was not possible to achieve evaluation levels 1 or 2. Under all dispersing conditions the dispersing energy employed was insufficient. The filtercake used, therefore, was much more difficult to disperse than the pasty pigment preparation from Example 12 produced from it.

### XV. Example 14

A black iron oxide pigment produced by the precipitation method was filtered after synthesis, washed free of salt and dried using a disc spray drier. Then, in a mixture of 22.3 kg of water and 8.55 kg of an 8% strength Mowiol® 40-88 solution, 39.5 g of Walocel CRT 40000GA, in each case as a thickener, were dissolved. Stirred into this solution were 33.75 kg of the dry black pigment powder, which was dispersed using a bead mill with 1 mm grinding beads of zirconium oxide, giving a dispersion with a pigment content of 52%. 1.44 kg of this dispersion were transferred to an IKA® HKD 2.5 horizontal compounder with DUPLEX blades, and, in the course of kneading, over a period of approximately 5 minutes, 30 g were added of a room-temperature-saturated potassium tetraborate pentahydrate solution, as compound which in combination with a thickener together increases firmness. Then kneading and homogenization were continued for 30 minutes more. This gave a pigment preparation of pasty consistency.

The pasty pigment preparation produced did not exhibit any colouring effect on dry and smooth surfaces in accordance with the test method described, since the average increase in mass of the bulk was 0.00 g. Moreover, it showed no phase separation over a period of several months. When the dispersibility in water was determined in accordance with the method described, it dissolved completely within 60 s.

Testing in building materials: 23 g of the pasty pigment preparation were dissolved with stirring in 164 g of water and the resulting suspension was used for the building material colour test described. The result was blocks with a homogeneous black colouration.

Testing in emulsion paint: 11.5 g of the pasty pigment preparation produced were used for the above-described determination of dispersibility in emulsion paints. The result was as follows:

| | |
|---|---|
| 10 min at 1000 rpm | evaluation level: 1 |
| 20 min at 2000 rpm | evaluation level: 1 |
| 10 min at 4500 rpm | evaluation level: 1 |

Evaluation level 1 was reached after 10 min at 1000 rpm. Even at the lowest dispersing energy, therefore, the pasty pigment preparation exhibited very good dispersibility.

### XVI. Example 15

The pasty pigment preparation from Example 14 was frozen in an airtightly sealable container at −11° C. for 60 hours. It was then thawed again to room temperature. The thawed pasty pigment preparation showed no differences from the original pigment preparation. No water had separated out. In the determination of the dispersibility in water in accordance with the process described it still dissolved completely within 60 s.

Testing in building materials: 23 g of the rethawed pasty pigment preparation were dissolved with stirring in 164 g of water and the suspension obtained was used for the above-described building material colour test. The result, again, was blocks with a homogeneous black coloration. There was no apparent difference from the blocks from Example 14.

Testing in emulsion paint: 11.5 g of the pasty pigment preparation thawed were used for the above-described determination of dispersibility in emulsion paints. The result was as follows:

| | |
|---|---|
| 10 min at 1000 rpm | evaluation level: 1 to 2 |
| 20 min at 2000 rpm | evaluation level: 1 |
| 10 min at 4500 rpm | evaluation level: 1 |

Evaluation level 1 to 2 was reached after 10 min at 1000 rpm. Even at the lowest dispersing energy, therefore, the pasty pigment preparation exhibited outstanding dispersibility.

The pasty pigment preparation produced, therefore, had not been impaired as a result of the freezing and thawing.

### XVII. Example 16

### Comparative Example to Examples 14 and 15

Testing in building materials: For comparison, 12 g of the dry black pigment powder used to produce the pasty pigment preparation from Example 14 were dispersed with stirring in 175 g of water and the resulting suspension was used for the above-described building material colour test. Again, blocks with a homogeneous black coloration were obtained. There was no apparent difference from the blocks coloured using the gellike pigment preparations from Examples 14 and 15.

Testing in emulsion paint: For comparison, 6 g of the dry black pigment powder used for producing the pasty pigment preparation from Example 14 were used for the above-described determination of dispersibility in emulsion paints. The result was as follows:

| | |
|---|---|
| 10 min at 1000 rpm | evaluation level: 5 |
| 20 min at 2000 rpm | evaluation level: 4 to 5 |
| 10 min at 4500 rpm | evaluation level: 2 |

With the dried black pigment powder used, very intense dispersing conditions were selected in order to achieve effective dispersing (evaluation level 2). The dried black pigment powder used, therefore, was much more difficult to disperse than the pasty pigment preparations from Examples 14 and 15.

### XVIII. Example 17

33 g of Mowiol® 8-88, as a thickener, were dissolved in 656 g of water with gentle warming. Then, with dispersion, 800 g of Tronox® A-Z (titanium dioxide pigment, commercial product of Tronox Inc.) were added. The dispersion was transferred to an IKA® HKD 2.5 horizontal compounder with DUPLEX blades, and 25 g of solid sodium tetraborate pentahydrate, as a compound which in combination with a thickener together increases firmness, were added in portions. Then kneading and homogenization were continued for 10 minutes more. This gave a pigment preparation of pasty consistency.

The pasty pigment preparation produced exhibited no colouring effect on dry and smooth surfaces in accordance with the test method described, since the average increase in mass of the bolt was 0.012 g. Moreover, it did not show any phase separation over a period of several months.

### XIX. Example 18

6.8 g of carubine, as a thickener, were dissolved in 675 g of water with heating to more than 80° C. The carubine solution was transferred to an IKA® HKD 2.5 horizontal compounder with DUPLEX blades, and 1 ml of Preventol® D6, as a preservative, was added. Then, in portions 6.8 g of Kelzan® (xanthane, commercial product of CP Kelco Germany GmbH) were added, as a further thickener, until a homogeneous composition formed. Gradually, in portions, 825 g of Bayferrox® 130 (red iron oxide pigment, commercial product of Lanxess Deutschland GmbH) were added to this composition and incorporated with kneading. Then kneading and homogenization were continued for 30 minutes more. This gave a pigment preparation with a pasty, rubbery consistency. As a result of its production at relatively high temperatures, some of the water had evaporated, and the pasty, rubbery pigment preparation produced had a pigment content of 57.5% by weight.

The pasty, rubbery pigment preparation produced did not exhibit any colouring effect on dry and smooth surfaces in accordance with the test method described, since the average increase in mass of the bolt was 0.08 g. Moreover, it did not exhibit any phase separation over a period of several months.

Testing in building materials: 20.8 g of the pasty, rubbery pigment preparation were admixed with 10% by weight of sodium periodate and left to stand for 24 hours. In the course of this time the pasty, rubbery pigment preparation underwent reliquefaction. The liquefied pasty pigment preparation was suspended with stirring in 166.2 g of water, and the suspension obtained was used for the above-described building material colour test. This gave blocks with a homogeneous red coloration.

### XX. Example 19

For further homogenization, the pasty, rubbery pigment preparation from Example 18 was heated at 85 to 90° C. for a short time in a sealed container. The pasty pigment preparation underwent liquefaction; as it cooled, a pigment preparation of pasty, rubbery consistency was formed again. As a result of its homogenization at relatively high temperatures, a further part of the water had evaporated, and the pasty, rubbery pigment preparation obtained had a pigment content of 58.6% by weight.

The pasty, rubbery pigment preparation produced did not exhibit any colouring effect on dry and smooth surfaces in accordance with the test method described, since the average increase in mass of the bolt was 0.02 g. Moreover, it did not exhibit any phase separation over a period of several months.

Testing in building materials: 20.4 g of the pasty, rubbery pigment preparation were admixed with 10% by weight of sodium periodate and left to stand for 24 hours. In the course of this time the pasty, rubbery pigment preparation underwent reliquefaction. The liquefied pasty pigment preparation were suspended with stirring in 166.6 g of water, and the suspension obtained was used for the above-described building material colour test. This gave blocks with a homogeneous red coloration. There was no apparent difference from the blocks from Example 18.

### XXI. Example 20

3.75 g of carubine, as a thickener, were dissolved in 750 g of water with heating to more than 80° C. The carubine solution was transferred to an IKA® HKD 2.5 horizontal compounder with DUPLEX blades, and 1 ml of Preventol® D6, as a preservative, was added. Then, in portions 7.5 g of Kelzan® were added, as a further thickener, until a homogeneous composition formed. Gradually, in portions, 750 g of Bayferrox® 130 (red iron oxide pigment, commercial product of Lanxess Deutschland GmbH) were added to this composition and incorporated with kneading. Finally, in addition, 45 g of Aerosil® 200 (hydrophilic fumed silica, commercial product of Degussa GmbH) were added as a filler. Then kneading and homogenization were continued for 30 minutes more. This gave a pigment preparation with a pasty, rubbery consistency. As a result of its production at relatively high temperatures, some of the water had evaporated, and the pasty, rubbery pigment preparation produced had a pigment content of 54.5% by weight.

The pasty, rubbery pigment preparation produced did not exhibit any colouring effect on dry and smooth surfaces in accordance with the test method described, since the average increase in mass of the bolt was 0.12 g. Moreover, it did not exhibit any phase separation over a period of several months.

Testing in building materials: 22 g of the pasty, rubbery pigment preparation were admixed with 10% by weight of sodium periodate and left to stand for 24 hours. In the course of this time the pasty, rubbery pigment preparation underwent reliquefaction. The liquefied pasty pigment preparation was suspended with stirring in 165.7 g of water, and the suspension obtained was used for the above-described building material colour test. This gave blocks with a homogeneous red coloration.

### XXII. Example 21

### Comparative Example to Examples 18, 19 and 20

Testing in building materials: For comparison, 12 g of the Bayferrox® 130 powder used to produce the gellike pigment preparations from Examples 18, 19 and 20 were dispersed with stirring in 175 g of water and the resulting dispersion was used for the above-described building material colour test. Again, blocks with a homogeneous red coloration were obtained. There was no apparent difference from the blocks coloured using the gellike pigment preparations from Examples 18, 19 and 20.

### XXIII. Example 22

For further homogenization, the pasty, rubbery pigment preparation from Example 20 was heated at 85 to 90° C. for a short time in a sealed container. After cooling, a pigment preparation of pasty, rubbery consistency formed again within a few days.

The pasty, rubbery pigment preparation produced did not exhibit any colouring effect on dry and smooth surfaces in accordance with the test method described, since the average increase in mass of the bolt was 0.01 g. Moreover, it did not exhibit any phase separation over a period of several months.

### III. The Figures

The bolt for testing the colouring effect on dry and smooth surfaces, and also the dimensional stability of the pigment preparation, are illustrated by reference to a number of figures. In this case the figures indicate further inventive features and advantages of the invention. In these figures:

FIG. 1 Shows a bolt of bright-drawn V4A round steel (material 1.4571) with a diameter of 8 mm and a length of 200 mm. One end of the bolt is machined to a point over a length of 10 mm. The bolt is used for testing the colouring effect on dry and smooth surfaces.

FIG. 2: Gellike pigment preparation from Example 1. The photos are intended to demonstrate the dimensional stability. A one euro coin is used for size comparison.

FIG. 3: Gellike pigment preparation from Example 3. The photos are intended to demonstrate the dimensional stability. A one euro coin is used for size comparison.

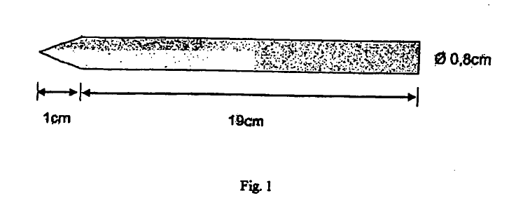

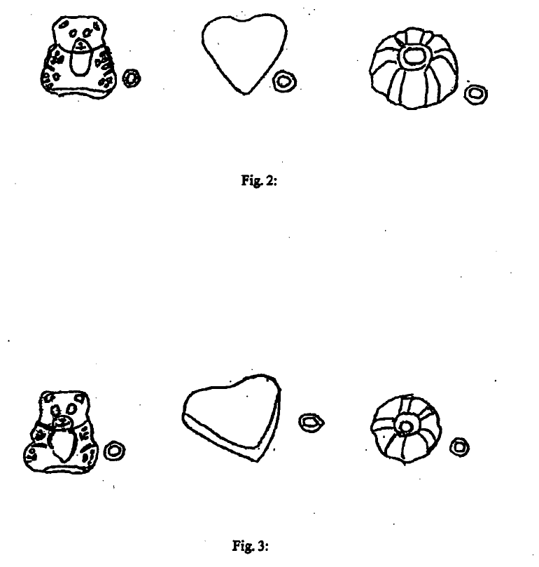

The invention claimed is a:

1. Pigment preparation for colouring lime-bound and/or cement-bound building materials, asphalt, paints, varnishes, paper or plastics, comprising:
one or more organic pigments comprising azo, quinacridone, phthalocyanine and perylene pigments and indigoids or mixtures thereof and/or
one or more inorganic pigments comprising iron oxide, titanium dioxide, chromium oxide, zinc oxide and rutile mixed-phase pigments and carbon black (carbon pigments) or mixtures thereof
are dispersed in a liquid; wherein
the pigment preparation has a pigment content of at least 15% by weight based on the pigment preparation and
at least one thickener and/or at least one thickener in combination with one or more compounds which together increase firmness is added in a total amount from 0.001 to 10% by weight based on the pigment preparation;
the pigment preparation:
being of pasty or gellike consistency; and
not tending towards phase separation.

2. Pigment preparation according to claim 1, wherein the liquid used is water or a water-miscible liquid or a mixture of at least two water-miscible liquids.

3. Pigment preparation according to claim 1, wherein the liquid used is a water-immiscible liquid or a mixture of at least two water-immiscible liquids.

4. Pigment preparation according to claim 1, wherein the pigment preparation has a pigment content of at least 25% by weight based on the pigment preparation.

5. Pigment preparation according to claim 1, wherein the thickeners used are organic thickeners such as organic natural thickeners, organic modified natural substances, organic all-synthetic thickeners, organic associative thickeners or low molecular mass organic products.

6. Pigment preparation according to claim 1, wherein the thickeners used are inorganic thickeners.

7. Pigment preparation according to claim 1, wherein the at least one thickener in combination with the one or more compounds which together increase firmness is used in a total amount from 0.1 to 5% by weight, based on the pigment preparation.

8. Pigment preparation according to claim 1, wherein
the thickeners used are algal extracts such as agar agar, carrageenans in the iota, kappa or lambda form, alginates such as sodium alginate or calcium alginate, extrudates of microorganisms or plants, such as xanthan and its derivatives, gellan, gum arabic, tragacanth, karaya gum or ghatti gum, endosperms of the seeds of fruits or plants, such as carob flour, carubine or tara flour, fruit extracts such as pectins, thickeners of animal origin such as protein derivatives and gelatines from cattle, pigs, fish, and also caseinates, or mixtures of these compounds; and
the compound or compounds used which in combination with at least one thickener together increase firmness, are among the carbonates, hydrogen carbonates, sulphates, glycerol phosphates, borates, chlorides, nitrates, phosphates, acetates, hydroxides of monovalent, divalent or trivalent metal salts and more particularly among salts of the alkali metals and alkaline earth metals, such as sodium potassium, magnesium, calcium or strontium salts such as sodium nitrate, potassium nitrate, magnesium nitrate, calcium nitrate, strontium nitrate, sodium borates, potassium borates, calcium borates, magnesium borates, sodium chloride, potassium chloride, magnesium chloride, calcium chloride, strontium chloride, sodium sulphate, potassium sulphate, magnesium sulphate, calcium sulphate, calcium phosphate, magnesium acetate, calcium acetate or from mixtures of these salts, the amount of the compound or compounds being situated in a range from 0.001% to 3% by weight and more particularly in the range from 0.1% to 1.5% by weight, based on the total weight of the pigment preparation.

9. Pigment preparation according to claim 1, wherein the thickeners used are partly or fully hydrolysed polyvinyl alcohols and also their derivatives or other polyhydroxy compounds in combination with boron compounds, more particularly ortho-boric acid, tetra-boric acid, meta-boric acid or their salts, or in combination with salts or complexes of elements from transition groups IV to VI of the Periodic Table of the Elements, more particularly of titanium, vanadium and chromium, such as titanium(III) salts or titanium(IV)-triethanolamine, where appropriate with the pH set to neutral or slightly alkaline.

10. Pigment preparation according to claim 1, wherein the auxiliaries used are wetting agents and/or dispersing additives and/or emulsifiers and/or preservatives and/or defoamers and/or retention agents and/or anti-settling agents and/or fragrances.

11. Pigment preparation according to claim 10, wherein the auxiliaries are used in a total amount from 0.001% to 10% by weight based on the pigment preparation.

12. Pigment preparation according to claim 10, wherein the auxiliaries are used in a total amount of from 0.05% to 5% by weight based on the pigment preparation.

13. Pigment preparation according to claim 1, wherein the pigment preparation does not tend towards phase separation over a period of at least two months.

14. Pigment preparation according to claim 13, wherein the pigment preparation does not tend towards phase separation over a period of at least six months.

15. Pigment preparation according to claim 1, wherein the pigment preparation exhibits only a slight colouring effect on dry and smooth surfaces, such as metal, glass, ceramic, textiles or plastics.

16. Pigment preparation according to claim 15, wherein the pigment preparation exhibits no colouring effect on dry and smooth surfaces, such as metal, glass, ceramic, textiles or plastics.

17. Pigment preparation according to claim 15, wherein the colouring effect amounts on average to not more than 0.15 g according to the test method disclosed in the description for the colouring effect on dry and smooth surfaces.

18. Pigment preparation according to claim 15, wherein the colouring effect amounts on average to not more 0.07 g according to the test method disclosed in the description for the colouring effect on dry and smooth surfaces.

19. Pigment preparation according to claim 1, wherein the pigment preparation further comprises at least one filler in an amount of not more than 40% by weight based on the pigment preparation.

20. Pigment preparation according to claim 19, wherein the amount of the at least one filler is not more than 10% by weight, based on the pigment preparation.

21. Method of preparing a pigment preparation according to claim 1, comprising
mixing one or more organic and/or inorganic pigments in a liquid to obtain a dispersion;
either before, during or after obtaining the dispersion, adding at least one thickener and/or at least one thickener in combination with one or more compounds which together increase firmness and mixing to obtain a pasty or gellike pigment, and
homogenizing the pasty or gellike pigment preparation.

22. Method of preparation according to claim 21, wherein the addition of at least one thickener and/or at least one thickener in combination with one or more compounds which together increase firmness takes place at or above room temperature.

23. Method of preparation according to claim 21, wherein as the at least one thickener organic or inorganic thickeners are added.

24. Method of preparation according to claim 21, wherein the organic thickeners used are partly or fully hydrolysed polyvinyl alcohols and also their derivatives or other polyhydroxy compounds in combination with boron compounds, such as ortho-boric acid, tetra-boric acid, meta-boric acid or their salts, or in combination with salts or complexes of elements from transition groups IV to VI of the Periodic Table of the Elements.

25. Method of preparation according to claim 24, wherein the complexes of elements from transition groups IV to VI of the Periodic Table of the Elements are titanium, vanadium and chromium, titanium(III) salts or titanium(IV)-triethanolamine.

26. Method of preparation according to claim 21, wherein the dispersion of one or more organic and/or inorganic pigments in a liquid is a dispersion from the pigment preparation process.

27. Method of preparation according to claim 21, wherein the dispersion of one or more organic and/or inorganic pigments in a liquid is a redispersion of previously agglomerated particles.

28. Method of preparation according to claim 21, wherein, before, during or after mixing one or more organic and/or inorganic pigments in a liquid to obtain a dispersion the addition of at least one organic or inorganic thickener and/or at least one thickener in combination with one or more compounds which together increase firmness takes place in a stirrer, mixer, compounder or dissolver.

29. Method of preparation according to claim 21, wherein the homogenizing of the pasty or gellike pigment preparation takes place in a stirrer, mixer, compounder or roll mill.

30. Method of preparation according to claim 21, wherein the homogenizing takes place under reduced pressure.

31. Method of colouring lime-bound and/or cement-bound building materials, asphalt, paints, varnishes, paper or plastics with the pigment preparation according to claim 1, comprising: mixing the pigment preparation with the lime-bound and/or cement-bound building materials, asphalt, paints, varnishes, paper or plastics.

32. Method of colouring according to claim 31, wherein the pigment preparation, before or during its addition to the lime-bound and/or cement-bound building materials, asphalt, paints, varnishes, paper or plastics and/or during the operation of mixing with the lime-bound and/or cement-bound building materials, asphalt, paints, varnishes, paper or plastics, is liquefied, the liquefaction taking place by:
dissolution in one or more liquids and/or
addition of an acid or alkali through a change in pH and/or
chemical reaction, more particularly redox reactions, or enzymatic reaction and/or
supply of heat, mechanical energy and/or ultrasound.

33. Method of colouring according to claim 31, wherein the pigment preparation is mixed with the lime-bound and/or cement-bound building materials, asphalt, paints, varnishes, paper or plastics in an amount from 0.01% to 15% by weight based on the overall mixture.

34. Method of colouring according to claim 33, wherein the pigment preparation is mixed with the lime-bound and/or cement-bound building materials, asphalt, paints, varnishes, paper or plastics in an amount from 0.1% to 10% by weight based on the overall mixture.
